(19) United States
(12) Patent Application Publication
(10) Pub. No.: US 2026/0205952 A1
(43) Pub. Date: Jul. 16, 2026

(54) DYNAMIC CONTROL OF RADIO FREQUENCY DEVICE POWER MODE

(71) Applicant: QUALCOMM Incorporated, San Diego, CA (US)

(72) Inventors: Satish KUMAR, Hyderabad (IN); Anshuman MISHRA, Hyderabad (IN); Sarath PINAYOUR CHANDRASEKARAN, Hyderabad (IN)

(21) Appl. No.: 19/017,270

(22) Filed: Jan. 10, 2025

(51) Int. Cl. H04W 52/02; H04W 4/80

(52) U.S. Cl. CPC H04W 52/0245; H04W 4/80

(57) ABSTRACT

Methods and apparatus for dynamically controlling a power mode of a wireless device are disclosed. Techniques may include receiving, at the wireless device, a radio frequency (RF) signal from a base station; transmitting an RF signal to the base station responsive to the RF signal from the base station; receiving signal power information from the base station, the signal power information being indicative of signal power capabilities of the base station; and adjusting a power mode of the wireless device to a passive mode or a semi-passive mode based on a signal strength of the RF signal received from the base station, a signal strength of the transmitted RF signal sent to the base station, and the signal power information.

### BACKGROUND

### 1. Field of Disclosure

The present disclosure relates generally to the field of wireless communications, and more specifically to, e.g., adjusting transmit powers of radio frequency (RF) signals with respect to wireless devices, and adjusting power modes of wireless devices.

### 2. Description of Related Art

Wireless-enabled devices can communicate with one another using RF signals. There are myriad types of wireless RF devices, such as mobile devices, Internet of Things (IoT) devices, and radio-frequency identification (RFID) devices configured to communicate with a network node. For example, the network node may be a base station that can act as a receiver. RFID is a rapidly growing technology that uses radio waves to exchange RF signals. RFID devices may be used for various use cases depending on whether they are operative as passive, semi-passive, or active RFID devices. In some cases, RFID can be used to automatically identify and/or track objects by reading information stored in small RF-enabled devices (such as RFID transponders or tags), monitor an area, or otherwise communicate with a network node such as a base station.

### BRIEF SUMMARY

In some aspects of the present disclosure, a method of dynamically controlling a power mode of a wireless device is disclosed. In some embodiments, the method may include: receiving, at the wireless device, a radio frequency (RF) signal from a base station; transmitting an RF signal to the base station responsive to the RF signal from the base station; receiving signal power information from the base station, the signal power information being indicative of signal power capabilities of the base station; and adjusting a power mode of the wireless device to a passive mode or a semi-passive mode based on a signal strength of the RF signal received from the base station, a signal strength of the transmitted RF signal sent to the base station, and the signal power information.

In some aspects of the present disclosure, a wireless device is disclosed. In some embodiments, the wireless device may include: one or more wireless communication interfaces; one or more memories; a power source; and one or more processors communicatively coupled with the one or more wireless communication interfaces, the one or more memories, and the power source, wherein the one or more processors are configured to: receive a radio frequency (RF) signal from a base station; transmit an RF signal to the base station responsive to the RF signal from the base station; receive signal power information from the base station, the signal power information being indicative of signal power capabilities of the base station; and adjust a power mode of the wireless device to a passive mode or a semi-passive mode based on a signal strength of the RF signal received from the base station, a signal strength of the transmitted RF signal sent to the base station, and the signal power information.

In some aspects of the present disclosure, an apparatus is disclosed. In some embodiments, the apparatus may include: means for receiving, at the wireless device, a radio frequency (RF) signal from a base station; means for transmitting an RF signal to the base station responsive to the RF signal from the base station; means for receiving signal power information from the base station, the signal power information being indicative of signal power capabilities of the base station; and means for adjusting a power mode of the wireless device to a passive mode or a semi-passive mode based on a signal strength of the RF signal received from the base station, a signal strength of the transmitted RF signal sent to the base station, and the signal power information.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication network.

FIGS. 3A and 3B are illustrations of radio frequency (RF) devices that form a simple communication system using RF signals.

FIG. 4 is a diagram showing an example of a network environment having a base station serving RF devices.

FIG. 5 is a diagram illustrating example backscattered signal strengths between a base station and RF devices at different distances.

FIGS. 6A and 6B are diagrams illustrating differences in returning signal strengths with respect to different RF devices.

FIG. 7 is a diagram illustrating example backscattered signal strengths between a base station and RF devices at different distances after adjustment in power allocation, according to some embodiments.

FIG. 8A is a diagram representing examples of returning signal strengths with respect to different RF devices.

FIG. 8B is a diagram representing examples of returning signal strengths with respect to different RF devices of FIG. 8A after adjustment in transmit power, according to some embodiments.

FIG. 9A is another diagram representing examples of returning signal strengths with respect to different RF devices.

FIG. 9B is another diagram representing examples of returning signal strengths with respect to different RF devices of FIG. 9A after adjustment in transmit power, according to some embodiments

FIG. 10A is another diagram representing examples of returning signal strengths with respect to different RF devices.

FIG. 10B is another diagram representing examples of returning signal strengths with respect to different RF devices of FIG. 10A after adjustment in transmit power, according to some embodiments.

FIG. 11 is a diagram representative of various signal power capabilities with respect to a network node and an RF device, useful with some disclosed implementations.

FIG. 12 is a diagram showing an example environment scenario of a wireless environment where a base station and multiple active RF devices are located at different distances from the base station.

FIG. 13 is a flow diagram of an example method of dynamically controlling transmit power with respect to wireless devices, according to some embodiments.

FIG. 14 is a flow diagram of an example method of dynamically controlling a power mode of a wireless device, according to some embodiments.

FIG. 15 is a flow diagram of an example of another method of dynamically controlling a power mode of a wireless device, according to some embodiments.

FIG. 16 is a block diagram of an embodiment of a UE, which can be utilized in embodiments as described herein.

FIG. 17 is a block diagram of an embodiment of a base station, which can be utilized in embodiments as described herein.

FIG. 18 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may absolute location determination, relative location determination, ranging, or a combination thereof. Such positioning may include and/or be based on timing, angular, phase, or power measurements, or a combination thereof (which may include RF sensing measurements) for the purpose of location or sensing services.

In some embodiments described in the present disclosure, a network node such as a base station (e.g., gNB) may dynamically adjust its transmit power to equalize the power levels of signals received from RF devices (e.g., RFID devices). In certain scenarios, the base station may be serving RF devices placed at various distances, thereby resulting in received signals that have widely varying signal strengths. Hence, the base station may initially send a training signal to measure the path loss of backscattered signals from each RFID device (which may be passive or semi-passive RFID devices that would not fully rely on actively transmit signals), and adjust transmit powers of signals allocated for corresponding RFID devices accordingly. In some implementations, the base station can also dynamically adjust transmit power based on threshold triggers, mobility patterns, fixed intervals, or on-demand requests from RF devices.

In some embodiments described in the present disclosure, active or semi-passive RF devices may switch power modes and fall back to semi-passive or passive modes based on signal power parameters, including, e.g., power capabilities of the base station and a signal strength of the transmitted RF signal sent to the base station. In some implementations, an RF device may re-enter active mode or semi-active mode from a passive mode or from a fallback state. The RF device may send a request to the base station with an intent to switch to a higher power mode. In the case of a passive RFID device, it may backscatter a signal containing a request to change the power mode, where the backscattered signal may have unique signal characteristics.

Particular implementations of the subject matter described in this disclosure can be implemented to realize one or more of the following potential advantages. By implementing the approaches relating to adjustment of base station transmit power, the base station's automatic gain control (AGC) algorithm may avoid failure caused by excessively disparate signal strengths caused by distance of RF devices, obstacles, or interference.

By implementing the approaches relating to switching power modes of RF devices, energy can be conserved and RF device operation may become less complex, since active or semi-passive RF devices may expend energy when actively transmitting RF signals. When re-entering active or semi-passive mode, an RF device may operate at full capability; capabilities of an RF device may be less limited compared to operating in a fallback mode.

Additional details will follow after an initial description of relevant systems and technologies.

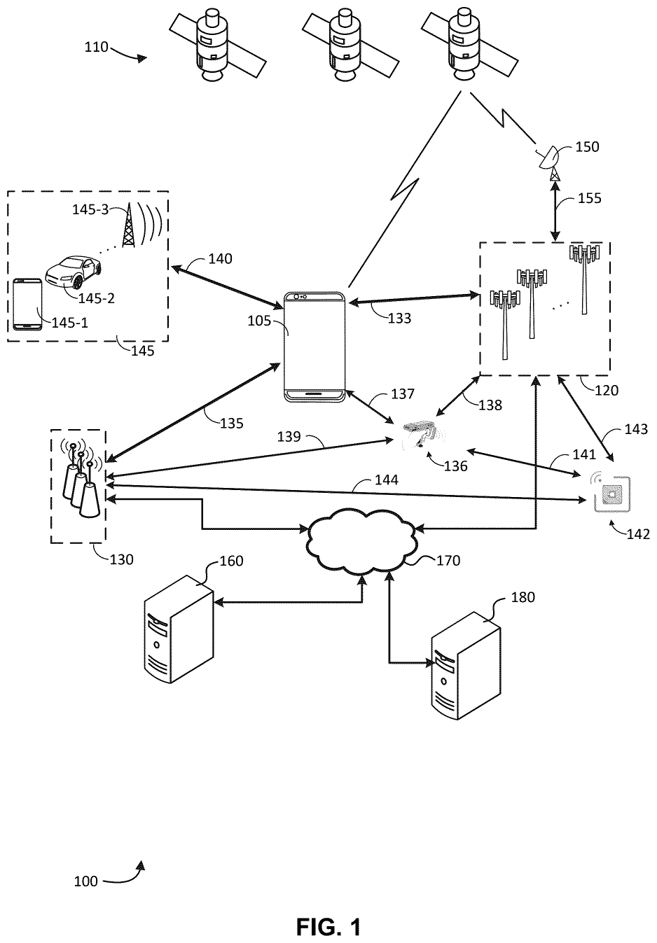

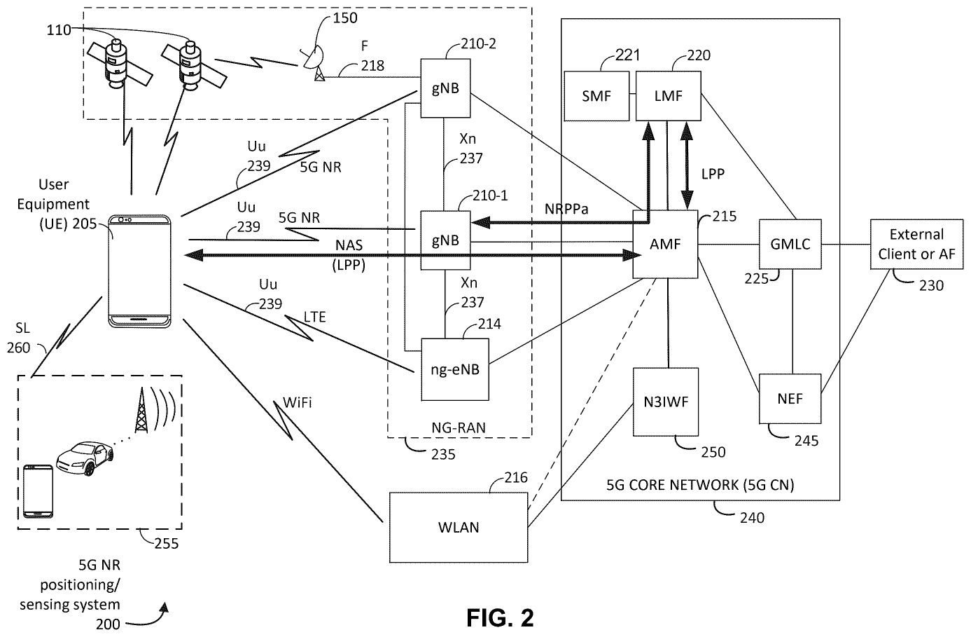

FIG. 1 is a simplified illustration of a positioning system 100 in which a UE 105, location server 160, and/or other components of the positioning system 100 can use the techniques provided herein for dynamically controlling transmit power with respect to wireless devices (such as UEs or other RF devices), or dynamically controlling a power mode of a wireless device (such as a UE or other RF device), according to some embodiments. The techniques described herein may be implemented by one or more components of the positioning system 100. The positioning system 100 can include: a UE 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and/or Non-Terrestrial Network (NTN) satellites; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other mobile devices 145.

Additionally, UE 105 can send and receive information with an RF reader (e.g., radio-frequency identification (RFID) reader) 136 via a third communication link 137. In some implementations, the third communication link 137 may utilize sidelink and/or similar Device-to-Device (D2D) communication technologies as described below. In some implementations, the third communication link 137 may utilize an IEEE 802.11 standard (including Wi-Fi), Bluetooth®, or another standardized communication technology. RF reader 136 may also be configured to communicate with UE 105 via the third communication link 137 and/or base station(s) 120 via a fourth communication link 138. In some implementations, the fourth communication link 138 may include a Uu interface (e.g., in LTE or NR) as described below. Downlink and uplink communications may be performed using the third and fourth communication links 137, 138. In addition, RF reader 136 may be configured to communicate with AP(s) 130 via a fifth communication link 139, which may utilize an IEEE 802.11 standard (including Wi-Fi), Bluetooth®, or another standardized communication technology (including cellular if capable). As will be further described below, the RF reader 136 may also be configured to interact with an RF device 142 (e.g., RFID tag or transponder). In some cases, the RF reader 136 may participate in IoT communication by emitting a carrier wave and receiving a backscattered wave, e.g., backscattered RF signals from the RF device 142 (e.g., an RFID tag) via communication link 141. In some cases, an active RF device may emit signals toward the RF reader 136, and the RF reader 136 may receive signals from the RF device.

In some scenarios, the RF device 142 may receive signals from various network entities, such as a base station 120 or an AP 130. For example, a base station 120 may serve one or more RF devices (including, e.g., RF device 142), which may involve sending a signal toward RF device 142 and receiving a signal back from the RF device 142 using a sixth communication link 143. Similarly, an AP 130 may send a signal toward one or more RF devices (including, e.g., RF device 142) and receive a signal back from the RF device 142 using a seventh communication link 144. As will be described further below, the base station 120 or the AP 130 may operate at a fixed output power or may adjust the output power.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

Satellites 110 may be utilized for positioning of the UE 105 in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the UE 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a location server 160. In some embodiments, satellites 110 used for NTN-based positioning may be different than those used for GNSS-based positioning. In some embodiments, NTN nodes may include non-terrestrial vehicles, which may be in addition or as an alternative to NTN satellites.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the UE 105, or a combination thereof. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the UE 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular UE 105, the UE 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., UE 105) may be facilitated using measurements from one or more anchor devices (e.g., mobile devices 145).

According to some embodiments, such as when the UE 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the UE 105, according to some embodiments.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 105 by using an LMF 220 (which may correspond with location server 160) to implement the one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network.

The 5G NR positioning system 200 may further utilize information from satellites 110. As previously indicated, satellites 110 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 110 may comprise NTN satellites that may be communicatively coupled with the LMF 220 and may operatively function as a TRP (or TP) in the NG-RAN 235. As such, satellites 110 may be in communication with one or more gNB 210.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of satellites 110, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, or WLAN 216) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220, described in more detail hereafter.

Positioning of the UE 205 in a 5G NR positioning system 200 further may utilize measurements between the UE 205 and one or more other UEs 255 via a sidelink connection SL 260. As shown in FIG. 2, the one or more other UEs 255 may comprise any of a variety of different device types, including mobile phones, vehicles, roadside units (RSUs), other device types, or any combination thereof. One or more position measurement signals sent via SL 260 to the UE 205 from the one or more other UEs 255, to the one or more other UEs 255 from the UE 205, or both. Various signals may be used for position measurement, including sidelink PRS (SL-PRS). In some instances, the position of at least one of the one or more of the other UEs 255 may be determined at the same time (e.g., in the same positioning session) as the position of the UE 205. In some embodiments, the LMF 220 may coordinate the transmission of positioning signals via SL 260 between the UE 205 and the one or more other UEs 255. Additionally or alternatively, the UE 205 and the one or more other UEs 255 may coordinate a positioning session between themselves, without an LMF 220 or even a Uu connection 239 to an access node of the NG-RAN 235. To do so, the UE 205 and the one or more other UEs 255 may communicate messages via the SL 260 using sidelink positioning protocol (SLPP). In some scenarios, the one or more other UEs 255 may have a Uu connection 239 with an access node of the NG-RAN 235 and/or Wi-Fi connection with WLAN 216 when the UE 205 does not. In such instances, the one or more other UEs 255 may operate as relay devices, relaying communications to the network (e.g., LMF 220) from the UE 205. In such instances, a plurality of other UEs 255 may form a chain between the UE 205 and the access node.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAoA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

### Allocating Transmit Power for RF Devices

Depending on the type of RF device, signal communication may use some to no internal power source. In some example operations, RF devices may be configured to emit (or reflect) an information-bearing signal upon receiving a signal. Based on their mode of transmission and power source, RF devices can be broadly categorized into three categories: passive, semi-passive, and active devices.

Passive RF devices may refer to RF devices that do not have an active power source. Hence, passive RF devices may only be able to backscatter signals (e.g., in response to reception of a signal) without any ability to amplify the signal; thus, their range may be limited (about 30 meters or less). Energy storage may be limited or not done at all with a passive RF device. Power consumption may be on the order of microwatts.

Semi-passive RF devices may refer to RF devices that do not have an active power source but can store some small amounts of energy from the RF signals. Semi-passive RF devices may be capable of backscattering received signals. Their own energy can be used to boost a backscattered signal if needed. Range may be moderate but higher than that of passive RF devices (about 60 meters or less). Power consumption may be on the order of 0.01 to 0.1 milliwatts.

Active RF devices may refer to RF devices that include an internal power source (or have access to a power source). Active RF devices may include on-board transmit and receive circuitry or systems that allow the device to send its own signals (e.g., in response to reception of a signal). Active RF devices may be configured to amplify transmit signals. Hence, their range may be greater than passive or semi-passive devices, up to about 100 to 300 meters, and device complexity may also be greater than that of passive and semi-passive devices. Power consumption may be higher, on the order of 0.1 to 1 milliwatt. Nonetheless, active RF devices may also be capable of backscattering (without using active transmission).

In some implementations, a switch within an active RF device or a semi-passive RF device may allow the device to toggle between actively transmitting signals (e.g., via transmit/receive circuit) and backscattering signals that are received.

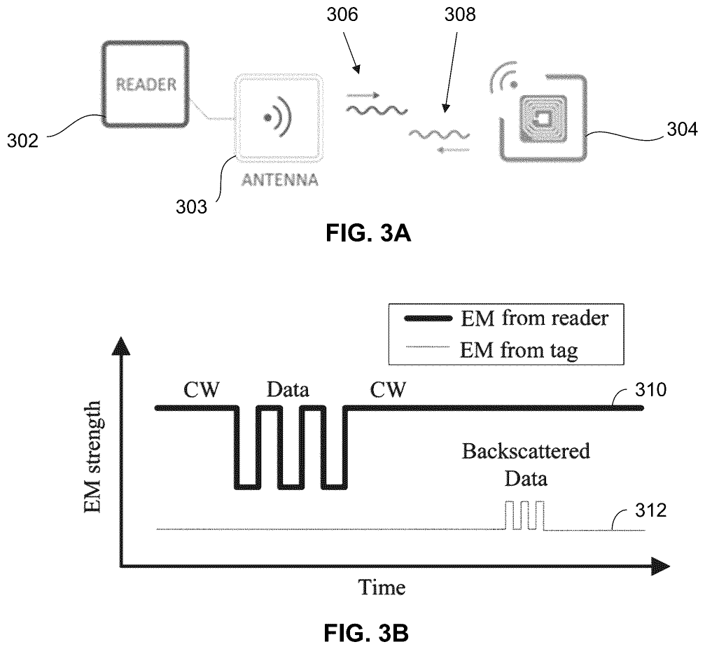

Backscattering mechanisms are discussed below with respect to FIG. 3.

Such RF devices can enable persistent contactless identification and/or information exchange with devices, impacting many industries with its potential for various applications. Illustrative examples of such applications include (but are not limited to) inventory and asset management (e.g., inside or outside a warehouse), Internet of Things (IoT), sustainable sensor networks in factories and/or agriculture, and smart networks or homes. In some configurations, the RF-enabled devices may include microchips, enabling these example operations using a small form factor. In some specific examples, passive RFID tags may be used for inventory or animal tracking (where RFID readers can be used to scan tags), passive and active RFID tags may be used in toll collection systems and access control systems, and active RFID tags may be used in supply chain or object monitoring over large areas, and semi-passive RFID tags may be used for environmental condition monitoring. Of course, RF devices having lower or higher power consumption may be used in similar applications. In some or all of these cases, the RF device or tag may be configured to exchange information with a network node, such as a base station or AP.

As illustrated in FIGS. 3A and 3B, RF readers and tags can form a simple communication system using backscattered RF signals. FIG. 3A is a diagram depicting an RF reader 302 (e.g., RFID reader) having an antenna 303, and an RF device 304 (e.g., RFID tag) exchanging a forward link and a backscatter link. A forward link may refer to an electromagnetic signal (also known as an interrogation signal) sent out by the RFID reader to energize RFID tag(s) 304 in the field, which may prompt a response from the tag(s) 304. A backscatter link may refer to an electromagnetic response signal sent from tag(s) 304 in the field, which may be detected by the reader 302.

FIG. 3B illustrates respective electromagnetic waves carrying information which are sent and received between a reader and a tag. A carrier wave 310 for the forward link may have been encoded to carry data. An RF reader (e.g., RFID reader 302) may modulate an RF signal (e.g., using a type of Amplitude Shift Keying) and use different encoding methods (e.g., using Pulse Interval Encoding as shown). An RF device (e.g., RFID tag 304) may respond with backscattered data corresponding to data in the carrier wave 310 for the forward link. The RFID tag 304 may send back data by switching the reflection coefficient of its antenna. Such backscattered data modulated and encoded (e.g., using methods different from the forward link, such as Phase Shift Keying modulation and FM0 Baseband encoding) in a corresponding carrier wave 312 may be detected and decoded by the reader. The amplitude of the backscattered link may be lower compared to that of the forward link.

In some examples, the RF device 304 may be a passive RF device since the signals may be backscattered. However, in other examples, an active or semi-passive RF device that is capable of emitting actively transmitted signals may use similar principles to exchange signals with the sending device. Moreover, in some examples, the RF device 304 may exchange signals with a base station (e.g., 120, such as a gNB) or an AP (e.g., 130). In active or semi-passive RF devices, the amplitude of the actively transmitted signals sent back to the sending device may be higher than that of the carrier wave 312.

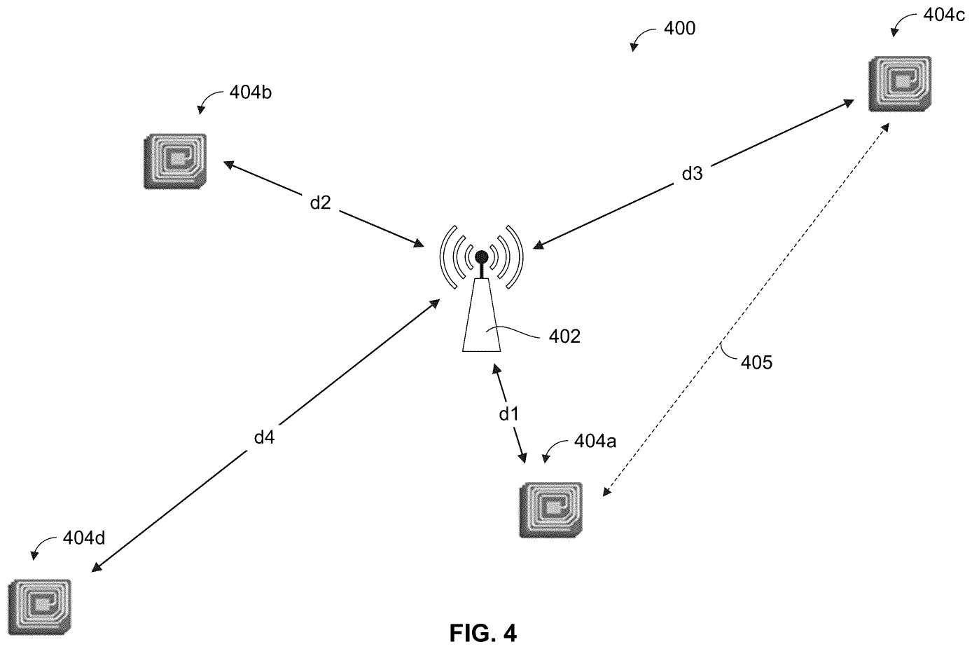

FIG. 4 shows a diagram showing an example of a network environment 400 having a base station 402 serving RF devices 404a, 404b, 404c, and 404d. In some implementations, each of RF devices 404a, 404b, 404c, and 404d may comprise a passive, semi-passive, or active RF device. For instance, at least one of RF devices 404a, 404b, 404c, or 404d may be an RFID tag. Active or semi-passive RFID tags may have an internal power source (e.g., battery) or otherwise have access to power, while passive RFID tags may not have access to its own power source. In other instances, RF devices 404a, 404b, 404c, or 404d may be other types of RF-enabled devices. In some scenarios, one or more of RF devices 404a, 404b, 404c, or 404d may be IoT devices. In some cases, such IoT devices may be capable of communication (e.g., wireless or otherwise) with one another, e.g., via an example communication link 405 between devices.

In some examples, RF device 404a may be at a first distance (d1) from the base station 402, RF device 404b may be at a second distance (d2) from the base station 402, RF device 404c may be at a third distance (d3) from the base station 402, and RF device 404d may be at a fourth distance (d4) from the base station 402. The base station 402 may comprise a gNB in some examples, or another type of access node in other examples. In this illustrative scenario, RF device 404a may be the closest to the base station 402 such that d1 is the smallest, d2 may be greater than d1 but smaller than d3, d3 may be greater than d2 but smaller than d4, and RF device 404d may be the farthest from the base station 402 such that d4 is the largest (d1<d2<d3<d4).

In some implementations, the base station 402 may be configured to operate at a fixed output power. Hence, backscattered or returned signals from RF devices (e.g., 404a, 404b, and/or 404c) received at the base station 402 may vary in amplitude. That is, RF devices located closer may reflect higher power compared to RF devices located at a longer distance, leading to a difference in the power of backscattered signals coming from different RFID tags at the receiver. As an illustrative example, RF device 404a may be a passive RF device that is closer to the base station 402 than RF device 404b, another passive RF device in this example.

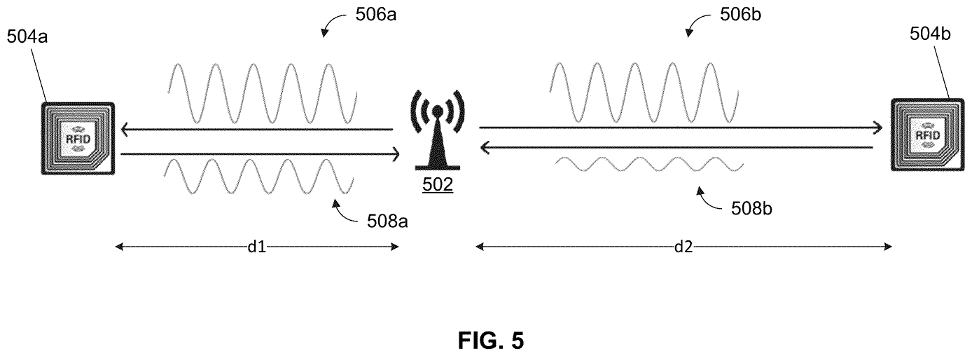

To illustrate this difference in power, refer briefly to FIG. 5, which shows an example of backscattered signal strengths between a base station 502 and RF devices 504a and 504b at different distances. In this example, RF device 504a may be at a distance d1 from the base station 502, and RF device 504b may be at a distance d2 from the base station 502. Distance d1 may be smaller than distance d2. RF device 504a may be closer to the base station 502 than RF device 504b. RF device 504a may be an example of RF device 404a, and RF device 504b may be an example of RF device 404b.

Initially, the base station 502 may transmit signals having the same signal strength to RF devices within its range. In some cases, base station 502 may transmit a training signal sequence to all the RF devices at the same strength and receive backscattered signals from RF devices placed at different distances. For example, transmitted signals 506a to RF device 502a and transmitted signals 506b to RF device 502b may have the same signal strength. Backscattered signals may have different powers since the RF devices are at different distances. For example, backscattered signals 508a received from RF device 502a may have a greater signal strength (represented by amplitude as shown) than backscattered signals 508b received from RF device 502b. The strengths of both transmitted and backscattered signals may be known to the base station 502 (e.g., in terms of transmit power and received signal strength). For example, RSSI may be an example of a measurement of signal strength, but those having skill in the relevant arts may recognize other method of measuring signal strength, such as for example signal-to-noise (SNR) ratio. As such, the base station 502 can compare values of transmit power and received signal strength for a given RF device to calculate the path loss (a measure of attenuation of electromagnetic waves along the propagation path between transmitter and receiver), which may allow the base station 502 to estimate distances to respective RF devices and have an idea of how near or far an RF device is situated.

The power offset or difference between the backscattered signals (e.g., as illustrated with 508a and 508b) can cause a scenario where an automatic gain control (AGC) algorithm fails to converge to an optimum operational gain state (GS) at the receiving device (here, the base station 502). AGC may be implemented by a network node, such as a base station (e.g., gNB) operating as a receiver. Such a network node may use AGC when receiving radio signals from wireless-enabled devices (e.g., RF devices, RFID devices, mobile devices) to handle varying signal strengths caused by distance, obstacles, or interference. Such a network node may prefer receiving signals to have a power level (representable by gain or amplification level) that is within a certain range so that its radio components can operate in their optimal condition. For example, if the receive chain of a base station is directly fed a receive power that is too high, the receive components may become saturated. The AGC algorithm may, in such cases, scale down the receive power. On the other hand, if the receive signal power is too low, AGC may amplify it. AGC may generally involve determining the appropriate gain state when receiving signals. Doing so can ensure optimal signal quality and prevent distortion or saturation, thus maintaining reliable communication in wireless networks. However, AGC may fail to converge (and find the appropriate gain) if signals having sufficiently different magnitudes are received at the same time. In some cases, AGC could determine a gain state which will not be favorable for all RF devices, or the gain state could work only for some of the RF devices. As wireless connectivity continues to grow, and in networks having ubiquitous wireless devices (e.g., RF devices, IoT devices), the complexity and magnitude of this challenge may also grow.

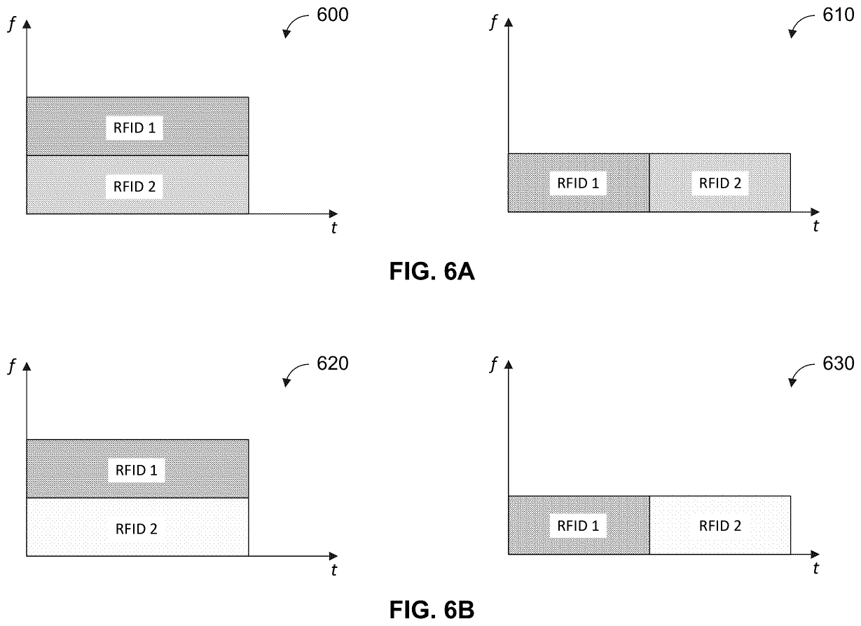

Referring now to FIGS. 6A and 6B, time-frequency diagrams 600 and 610, and 620 and 630, illustrating differences in returning signal strengths with respect to different RF devices are illustrated. Each time-frequency diagram represents signal strengths associated with two RF devices (“RFID 1” and “RFID 2”). For example, time-frequency diagrams 600 and 610 in FIG. 6A indicate that backscattered signals from RFID 1 and RFID 2 are at similar strengths, indicated by similar levels of shading. This may be because RFID 1 and RFID 2 are at similar distances from the receiver (e.g., base station). As can be noticed, signals may be sent and received at different frequencies (frequency-multiplexed according to time-frequency diagram 600) or different times (time-multiplexed according to time-frequency diagram 610).

When the strength of the backscattered signals are comparable as shown in FIG. 6A, the AGC algorithm can successfully find an optimum gain state suitable for both RFIDs. This leads to an ideal scenario where both the RFIDs co-exist without any degradation in their respective metrics.

However, if backscattered signals have a high power offset, e.g., because RFID 1 and RFID 2 are at different distances, one GS will not be suitable for both the RFIDs. Time-frequency diagrams 620 and 630 in FIG. 6B indicate that backscattered signals from RFID 1 and RFID 2 are at considerably different strengths, indicated by different levels of shading. Again, signals may be sent and received at different frequencies (frequency-multiplexed according to time-frequency diagram 620) or different times (time-multiplexed according to time-frequency diagram 630). However, the signal strength of backscattered signals from RFID 1 may be much higher (darker shade) than those from RFID 2, which could indicate that RFID 1 may be closer to the base station than RFID 2 is.

As a result, the AGC algorithm at the base station may operate at a higher GS, a lower GS, or a moderate GS, leading to a degradation in performance for one or both of the RFIDs. This issue can become more severe the more RF devices or tags coexist, or if the RF devices are distributed over a large area, or if distances from the base station keeps changing (e.g., in the case of mobile or IoT devices).

To avoid power offset issues between backscattered signals and maintain a power level above a receive sensitivity, a target backscattered power may be maintained. Although active RF devices have an internal power supply, power conservation is still considered as part of their operation. It is desirable that the power dissipation be as low as possible so that the devices can run for long durations without the need for recharge or battery change. Power savings may be even more important to semi-passive devices. It is also desirable for active or semi-passive devices to not have to maintain a received power level at the RF receiver (e.g., base station) for its AGC to work properly.

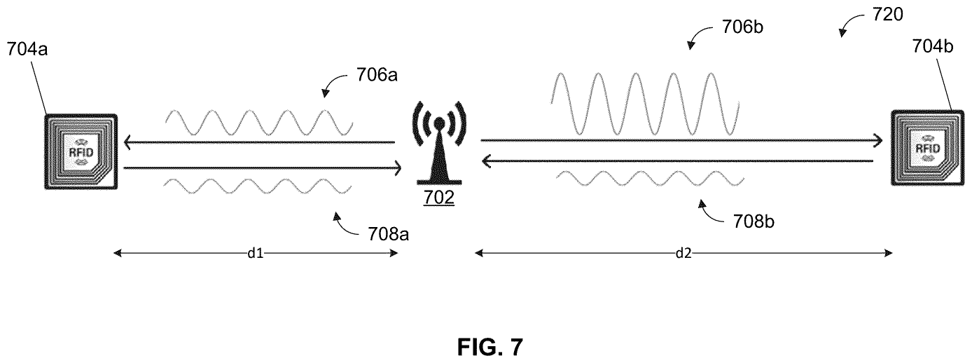

To these ends, the backscattered signal having more path loss may be compensated by transmitting the forward link signal from the receiver (e.g., a base station such as gNB) with higher power than the signal facing lesser path loss. FIG. 7 illustrates example backscattered signal strengths between a base station 702 and RF devices 704a and 704b at different distances after adjustment in power allocation, according to some embodiments. Similar to the FIG. 5 example, distance d1 may be smaller than d2 such that RF device 704a is closer to the base station 702 than RF device 704b. RF device 704a may be an example of RF device 404a, and RF device 704b may be an example of RF device 404b.

In this example, however, unlike the FIG. 5 example, transmitted signals 706a to RF device 702a and transmitted signals 706b to RF device 702b may have different signal strengths. For example, transmitted signals 706a from the base station 702 may have a lower signal strength than transmitted signals 706b (represented by different amplitudes as shown). Consequently, backscattered signals 708a and 708b may have similar signal strengths despite the RF devices 704a and 704b being at different distances and receiving signals of different power. The strengths of both transmitted and backscattered signals, and path losses of communication links between the base station 702 and respective RF devices, and hence the distances of the RF devices, may be known to the base station 702 (e.g., in terms of transmit power and received signal strength). In some cases, other parameters, such as motion or mobility of RF devices, any requests from the RF devices, or relevant thresholds for signal powers sent or received, may also be known to the base station 702.

This uneven power allocation between different RFIDs may result in the backscattered signals being received with substantially similar or substantially same (equal or within an acceptable difference that is minimal, which may vary depending on the RF device and the AGC algorithm) signal strength at the receiver base station. This minimal power offset will help in successful AGC convergence since a single optimal gain state appropriate for different RFIDs can be easily selected. Disclosed embodiments overcome the AGC problem at the RF receiver (e.g., base station) as well as power saving for RF devices.

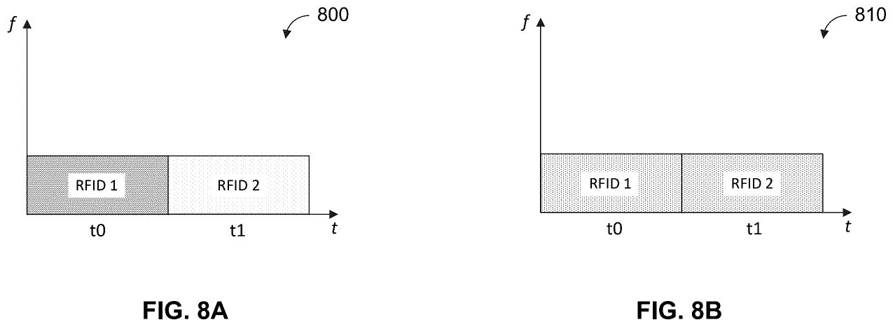

To illustrate the adjustment of power allocation, FIG. 8A shows an example of a time-frequency diagram 800 representing returning signal strengths with respect to different RF devices. In some configurations, a receiver such as a base station (e.g., a gNB) may be configured to perform signal communication with the RF devices and vice versa. Similar to the time-frequency diagram 630, RFID 1 and RFID 2 in the time-frequency diagram 800 may return backscattered signals to the base station at different signal strengths (indicated by different levels of shading). In some scenarios, RFID 1 and RFID 2 may be RF devices at different distances from the base station. For example, RFID 1 and RFID 2 may be examples of RF devices 404a and 404b or RF devices 704a and 704b.

In some embodiments, the receiver or base station may determine or estimate respective distances to multiple RF devices in its range. For example, as noted above, path loss based on transmit power and/or received signal strength may be used to determine a distance. Based on the path loss and/or the distance to a given RF device, the base station may adjust its transmit power to one or more of the multiple RF devices such that the backscattered signal powers from the multiple RF devices are substantially same or similar.

In some implementations, the base station may possess power information correlating transmit power to one or more of distance, path loss, and/or backscattered signal strength. Such information may be stored as, e.g., lookup table, graph, comma-separated values, matrix, or other data structure. The base station may be able to determine an appropriate adjustment based on the correlation.

For instance, to induce a signal strength associated with backscattered signals 708b (of RF device 704b) from RF device 704a (which is at a distance that is different from that of RF device 704b) so as to equalize backscattered signals 708a and 708b, the base station may decrease the transmit power to the RF device 704a (e.g., by amount x) according to the power information, e.g., to that of transmitted signals 706a.

As another example, the base station may decrease the transmit power to the RF device 704a by a smaller amount than example amount x above, while also increasing the transmit power to the RF device 704b (as opposed to, e.g., maintaining the transmit power). This approach may be used, for example, if the backscattered signal from RF device 704b is too weak (e.g., below a threshold), or if backscattered signal from RF device 704a should not be decreased too much (e.g., below a threshold).

The above examples may involve a comparison of backscattered signal strengths from the RF devices against one another. In some approaches, the backscattered signal strengths may be compared against a predetermined reference signal strength rather than one another. The network node may then adjust the transmit power to the RF devices based on such reference level.

In some cases, the power information may have been gathered by the base station over time, building correlations between different transmit powers and the received signal strengths from a given RF device. In some cases, the RF device may be mobile, and the correlations known by the base station may also include distance to the given RF device (as determined or estimated, e.g., using path loss as mentioned above).

In some implementations, correlation between transmit power and distance, path loss, or backscattered signal strength may be trained using a machine learning model. In such implementations, training data may include ground truth information including the aforementioned different transmit powers and the received signal strengths from a given RF device, estimated distances, and/or path loss. In some cases, various training signals of different known strengths may be sent to the given RF device (including at different distances in some cases) to allow the base station to measure returning backscattered signals.

As such, and will be described in greater detail below, the base station can maintain desirable received power levels to solve AGC optimally with at least passive and semi-passive RF devices (and in some cases, active RF devices in a mode that backscatters rather than actively transmits signals).

Referring again to FIG. 8A, in some examples, at time t0, RFID 1 may be dealt a different transmit power level as compared to RFID 2 at time t1. Different RF devices may have their own power requirements based on their distances from the base station, and thus, an appropriate increase and/or decrease of transmit power as discussed above may cause backscattered signals to be brought to a level for the AGC to be performed smoothly.

FIG. 8B shows an example of a time-frequency diagram 810 representing returning signal strengths with respect to different RF devices of FIG. 8A after adjustment in transmit power, according to some embodiments. It can be seen that RFID 1 and RFID 2 are now associated with backscattered signal strengths that are substantially equal or similar (indicated by similar levels of shading). In some approaches, this may be a result of an adjustment to one or more of the respective transmit powers to the two RF devices.

In some implementations, the base station may be configured to adjust the transmit power based on, e.g., power information relating to distance, path loss, and/or backscattered signal strength associated with each of the two (or more) RF devices.

It may be noticed that the shading of RFID 1 in time-frequency diagram 810 is lighter than that in time-frequency diagram 800, and the shading of RFID 2 in time-frequency diagram 810 is darker than that in time-frequency diagram 800, indicating that transmit power to both RF devices were adjusted. However, adjustment of transmit power for only one RF device may be possible as well.

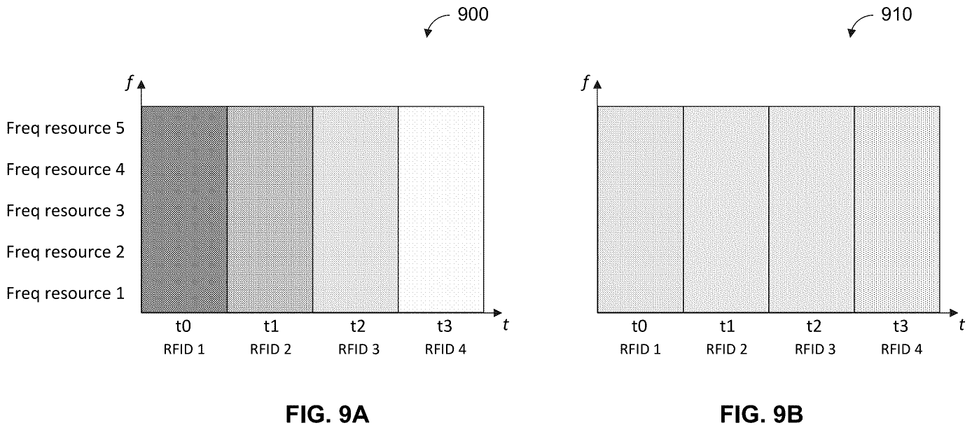

FIG. 9A shows another example of a time-frequency diagram 900 representing returning signal strengths with respect to different RF devices. In this example, a receiver base station may transmit a forward link signal to four RF devices and receive backscattered signals from the four RF devices. In some examples, the four RF devices (RFID 1, RFID 2, RFID 3, RFID 4) may be examples of RF devices 404a, 404b, 404c, and 404d, respectively. That is, in some examples, RFID 1 may be the closest RF device and RFID 4 may be the farthest RF device from the base station. Further, a time-frequency diagram 900 also indicates a set of frequency resources (1 through 5). According to the example of time-frequency diagram 900, however, the base station may transmit a signal to the RF devices at different times t0 through t3 on any of the frequency resources. As can be seen, RFID 1 has the darkest shade, indicating high backscattered signal power; RFID 4 has the lightest shade, indicating low backscattered signal power. Intuitively, since RFID 1 (an example of RF device 404a) may produce backscattered signals having the highest signal strength since it is at the closest distance out of the four RF devices, while RFID 4 (an example of RF device 404d) may produce backscattered signals having the lowest signal strength since it is at the closest distance. RFID 2 and RFID 3 may thus produce backscattered signals between that of RFID and RFID 4.

FIG. 9B shows another example of a time-frequency diagram 910 representing returning signal strengths with respect to different RF devices of FIG. 9A after adjustment in transmit power, according to some embodiments. It can be seen that RFID 1, RFID 2, RFID 3, and RFID 4 are now associated with backscattered signal strengths that are substantially equal or similar (indicated by similar levels of shading). In some approaches, this may be a result of an adjustment (increase or decrease) to one or more of the respective transmit powers to the four RF devices. In some implementations, transmit power for the RF devices may be selected according to their location and/or distance. In some cases, however, transmit powers for one or more RF devices may not be adjusted. The resulting backscattered signal strengths of the RF devices may, in some cases, not be exact. That is, there may be slight variations in the signal strengths and not equalized exactly, even if the backscattered power profile may appear identical (or nearly identical) across time. Such slight variations may be acceptable within a certain threshold or range. In some cases, such threshold or range may be such that the AGC may be performed smoothly by the receiver base station.

In some implementations, the base station may be configured to adjust the transmit power based on, e.g., power information relating to distance, path loss, and/or backscattered signal strength associated with each of the four (or more) RF devices.

In some examples, RF devices (e.g., RFID 1 through RFID 4) may have different capabilities and power requirements. As an illustrative example, RFID 1 may be a UE (e.g., a mobile device), RFID 2 may be an IoT device, RFID 3 may be a passive RF device, and RFID 4 may be an active RF device (performing backscattering without active transmission). Based on the signal strengths of backscattered signals from the RF devices, adjustment to one or more of the transmit powers to the RF devices may be such that the network node (e.g., base station) can converge to a gain state that can be used with the different types of devices in a heterogeneous network of devices, including legacy devices (e.g., UEs), IoT devices, and/or RF devices (e.g., RFID devices and passive RFID tags).

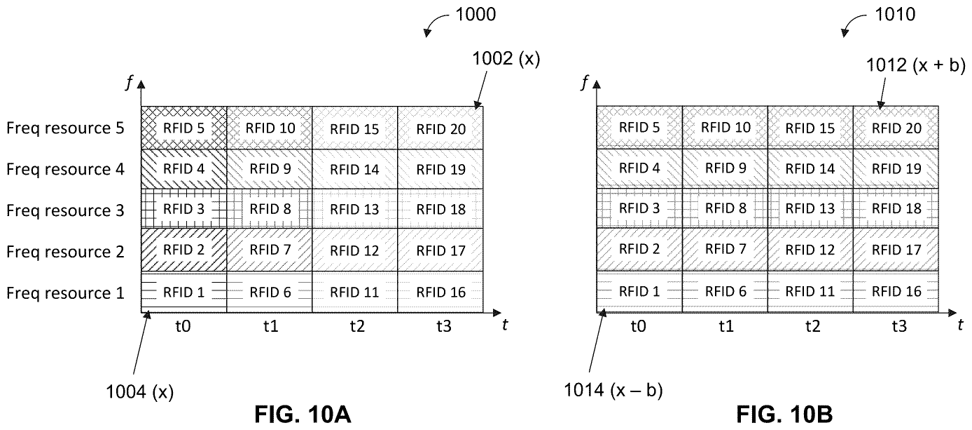

FIG. 10A shows yet another example of a time-frequency diagram 1000 representing returning signal strengths with respect to different RF devices. In some embodiments, a receiver (e.g., base station such as gNB) may be configured to transmit signals to numerous RF devices at different times as well as different frequencies. The division of frequency resources as well as time resources may allow the base station to communicate with even more RF devices, for example, compared to as illustrated in time-frequency diagram 900. In some scenarios, as indicated in time-frequency diagram 1000, the base station may be configured to communicate with 20 different RF devices: RFID 1 through RFID 20, which may be located at varying distances from the base station. In some cases, RF devices may be grouped temporally according to one or more characteristics. For instance, at least some of RFID 1 through RFID 5 may have a power requirement that varies among one another less than between RFID 1 and, say, RFID 6 through RFID 20, and hence, RFID 1 through RFID 5 may be served at one instance (e.g., time t0).

Signals 1002 and 1004 transmitted from the base station to the RF devices may initially have signal power x, each at a respective timing and frequency depending on the RF device. Backscattered signals may have varying signal strengths as illustrated. For example, backscattered signals received from RFID 1 (responsive to signal 1004) may have a higher signal power (indicated by a darker shade), while backscattered signals received from RFID 20 (responsive to transmitted signal 1002 at time t3) may have a lower signal power (indicated by a lighter shade).

The approach used with time-frequency diagram 900 (and 800) may be extended so that multiple RF devices with similar power needs are frequency multiplexed with an appropriate power offset by increasing (boosting) or decreasing (de-boosting) transmit power by the base station at a specific time and a specific frequency.

To illustrate, FIG. 10B shows yet another example of a time-frequency diagram 1010 representing examples of returning signal strengths with respect to different RF devices of FIG. 10A after adjustment in transmit power, according to some embodiments.

In some implementations, the base station may be configured to adjust the transmit power by increasing or decreasing it for at least some of the RF devices, which may result in similar backscattered responses across the RF devices, including across frequency resources. To enable the similar backscattered signal strengths across frequencies, the base station may adjust its transmit power at specific frequencies (e.g., frequency resources 1 through 5) as well, not just at the specific times (e.g., t0 through t3). For example, the base station may be configured to transmit a boosted signal 1012 having signal power x+b to RFID 20 at time t3 using frequency resource 5, and transmit a de-boosted signal 1014 having signal power x−b to RFID 1 at time t0 using frequency resource 1.

As an illustrative example, a set of five RF devices with similar power requirements may be allocated to time t0. In some cases, the similar power requirements may arise from being at similar distances. That is, RFIDs 1 through 5 may be at similar distances away from the base station (e.g., within a threshold distance range). Other different sets of RF devices with respective power requirements may be allocated to times t1, t2 and t3.

In some approaches, the transmit power at a given time (e.g., time t0) may be set to match the farthest RF device. As an example, RFID 1 may be the farthest out of RFIDs 1 through 5. The reference transmit power may match that associated with RFID 1. The rest of the RF devices RFIDs 2 through 5 (which in this example would be closer to the base station than RFID 1) may be de-boosted according to their individual power needs. As a result, the RF devices allocated to time t0 would have substantially same or similar backscattered signal strengths, as indicated by similar levels of shading in time-frequency diagram 1010.

In some approaches, the reference power for a given time (e.g., time t0) may match the closest RF device and the transmit power for the rest of the RF devices boosted accordingly. For example, RFID 3 may be the closest out of RFIDs 1 through 5. The reference power may be set to that associated with RFID 3, and the rest of the RF devices (which in this example would be farther from the base station than RFID 3) may be boosted according to their respective power needs. As a result, the RF devices allocated to time t0 would have substantially same or similar backscattered signal strengths, as indicated by similar levels of shading in time-frequency diagram 1010.

A similar approach may be used with other groups of RF devices allocated to each of times t1, t2 and t3 such that the backscattered signal strengths may be at least substantially equalized across RF devices being served, and AGC convergence happens across time instances t0, t1, t2, t3.

The reference power may not correspond to a particular RF device, such as the farthest or closest RF device. Instead, in some approaches, the transmit power may be adjusted to a level that is determined based on power information of at least some of the RF devices, where power information may include, e.g., distance, path loss, and/or backscattered signal strength associated with each of the at least some of the RF devices. In some examples, the reference power may be an average of the respective transmit power levels for the at least some of the RF devices which would be needed to produce a desired target backscattered signal strength, or needed to produce backscattered signal strengths that could enable optimal AGC (e.g., convergence of AGC within a threshold time or computing resource). Based on this reference power, the base station may adjust the transmit power associated with each RF device, increasing or decreasing the transmit power to meet the reference power.

In some cases, in the event that the boosting or de-boosting tolerance or limit is exceeded for an RF device, that RF device may be allocated to a different time instance, e.g., from time t1 to time t3.

Hence, signals transmitted from the receiver base station may have respective power characteristics to result in an evened out backscatter power profile, an example of which is shown in time-frequency diagram 1010 where signal strengths of backscattered signals from all 20 of the RF devices are substantially similar or substantially identical (indicated by all RFIDs having similar shading). In other words, the time-frequency diagram 1010 shows that the power gradient during reception of backscattered signals is relatively even, with very slight differences between signals at different frequency or time resources. At time t0, for example, RFID 1 was exposed to high transmit power from the receiver base station as it was presumably placed far from the base station, and received almost the same power as RFID 5 which had less power allocation as it was closer. Now that there is minimal power offset or difference associated with the backscattered signals, the resulting power offset can be easily handled by the AGC algorithm. Hence, the AGC algorithm may easily converge to a gain state level best suited for the RFIDs at each time and/or frequency resource.

In some embodiments, adjustment of the transmit power at the base station may be performed based on different factors.

In some implementations, the adjustment may be threshold based. More specifically, the base station may trigger an adjustment based on the difference in signal strengths between backscattered signals from RF devices crossing a certain threshold. Once this mechanism is triggered, the offsets can be reduced or eliminated, after which AGC by the base station can continue to function optimally until a threshold has been crossed again.

In some implementations, the adjustment may be mobility based. More specifically, transmit power may be adjusted based on how frequently the backscattered signal strength values are changing. For example, RSSI can provide an idea of distance to the RF device, changing RSSI may indicate a correlation to frequently changing distances (high mobility). In such scenarios, adjustment to the base station's transmit power may be performed more frequently at shorter intervals, to account for changing distances. In low mobility or static scenarios, e.g., as determined by infrequent changes in backscattered signal strengths, the power adjustment can be done less frequently, for instance, once at the beginning of the base station's transmission and the upcoming iterations after longer intervals.

In some implementations, the adjustment may be periodicity based. The transmit power adjustment in this case may be performed at fixed intervals irrespective of the mobility or the power offset as described above. Instead, the network may be configured to adjust the transmit power at a certain fixed periods (e.g., 10 frames, seconds, or other time periods). Once the power adjustment is done, another adjustment may be set off after another fixed period has passed.

In some implementations, the adjustment may be performed or initiated on demand from an RF device. For example, an active or semi-passive RF device that is low on energy (e.g., below a threshold) may fall back to passive power mode and let the base station begin controlling the transmit power according to any one of the aforementioned implementations.

In relation to said fallback of the RF device, some embodiments of the present disclosure may enable an active or semi-passive RF device to fall back to a lower power mode such as semi-passive or passive mode, or re-enter a more active power mode such as semi-passive or active mode from a fallen back state.

### Switching Power Mode of RF Devices

As mentioned above, broad categories of RF devices include active, semi-passive, and passive RF devices. Each of these types of devices may be considered to operate at a corresponding power mode. For instance, an active RFID device may operate in an active mode in which a power source (e.g., battery) that is internal or accessible to the device is used to actively generate and transmit signals. A semi-passive RFID device may also use some internal power, whereas a passive RFID device may not have or use its own power source.

Power conservation may be beneficial in some cases for active or semi-passive RF devices. For example, an active RFID device, when low on energy, should be able to fall back to operate in a lower power mode, such as semi-passive or passive mode, given that a network node such as a base station can boost the downlink power to still maintain decoding of backscattered signal from such devices.

To allow the above fallback mechanism, in some embodiments, signal power information may be sent from a network node (e.g., base station) that is operative as a receiver. In some implementations, the signal power information may indicate capabilities relating to the network node's signal transmissions and power, and may be broadcasted to various RF devices, and one or more of the RF devices may then use the signal power information, e.g., to estimate power requirements and select a power mode based on the power requirements. Examples of signal power information may include maximum transmit power of the network node, minimum transmit power of the network node, actual transmit power of the network node, and uplink power target of the network node.

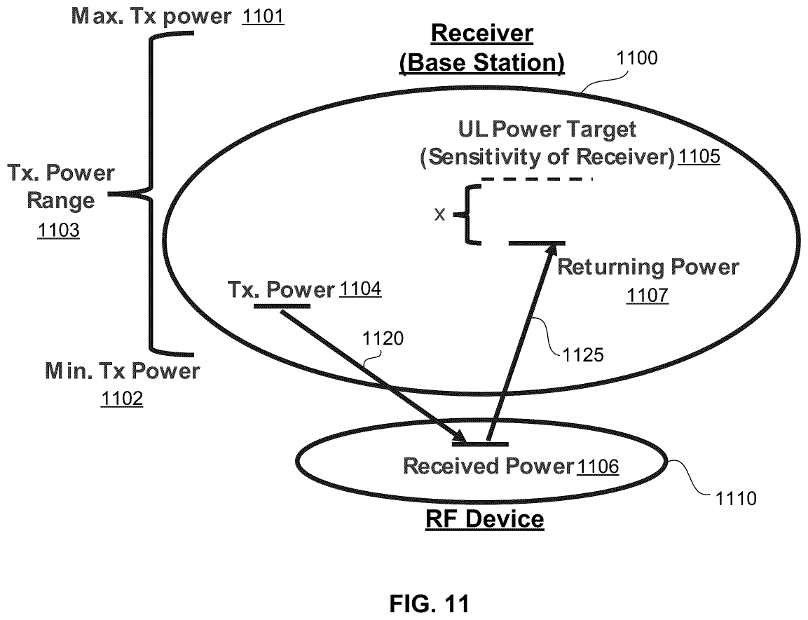

Referring to FIG. 11, a diagram representative of various signal power capabilities with respect to a network node 1100 and an RF device 1110 is shown. A network node operative as a receiver, such as a base station (e.g., gNB), may be associated with various power parameters.

One example of such signal power parameters is a maximum transmit power 1101, which may indicate an upper limit of the signal strength of wireless signals that the network node 1100 may transmit. In some cases, the maximum transmit power 1101 may indicate a global limit of the network node 1100. This upper limit is not specific to a particular device and is globally applicable regardless of device or device type.

On the other hand, the network node may be associated with a minimum transmit power 1102. That is, signals transmitted by the base station may not have a signal strength below the minimum transmit power 1102, which may be a global lower limit. Thus, the transmit power range 1103 indicates a range of transmit powers that the base station may be configured to send.

The network node may be further associated with an actual transmit power 1104. The actual transmit power 1104 may be specific to a given signal 1120 sent to the RF device 1110, and may be included with signal power information sent to the RF device 1110 with the given signal (or prior to or subsequent to sending the given signal).

The network node may be further associated with an uplink power target 1105, which may refer to a power level determined by the network node (based, e.g., on settings or capabilities of hardware or software used by the network node) to maintain efficient operation of the network node. The uplink power target 1105 may indicate a signal power that minimizes distortion and saturation, and may correspond to the optimum operational gain state of the network node. Hence, the uplink power target 1105 may be considered to indicate a sensitivity of the network node. If the uplink power target 1105 is low, then it is more sensitive to the signal strength of received signals, and if the uplink power target 1105 is high, then it is less sensitive to the received signals. Put another way, the lower the uplink power target 1105, the weaker the backscattered signals that can be detected by the network node, and vice versa. For example, if the uplink power targets of two receiving devices are −50 dBm and −100 dBm, the second device (with −100 dBm uplink power target) has a higher sensitivity and can detect signals more easily, including signals that are weaker, compared to the first device (with −50 dBm uplink power target).

At the RF device 1110, the signal 1120 sent by the network node may be received at a receive power 1106. Receipt of the signal 1120 may result in the RF device 1110 returning a signal 1125 having returning power 1107. In some scenarios, the returning signal 1125 may be a backscattered signal from the RF device 1110, which may be a passive RF device, or a semi-passive RF device or an active RF device not performing active transmission. In some scenarios, the returning signal 1125 may be at least partly actively transmitted by the RF device 1110, which may be an active RF device or a semi-passive RF device (which may backscatter the signal 1125 with some self-powered boosting).

In some implementations, once the signal power information (including one or more of maximum transmit power 1101, minimum transmit power 1102, actual transmit power 1104, or uplink power target 1105) is received by an RF device which has active transmit and/or receive capabilities, that RF device may register itself with the network node. The network node may then have knowledge of active and semi-passive RF devices that are in proximity and can be served.

The network node may have at least some awareness of which RF devices within range are passive or not. Some example approaches to determining the operational mode of the RF devices (e.g., passive or active) may include considering non-registered devices and devices performing backscattered communication (e.g., scrambled with a device identifier (ID) in a read procedure of RFID tags or passive devices) as passive RF devices. However, the network node may not be able to switch a passive RF device to an active mode, as the RF device in a passive mode would not have sufficient intelligence to decode a command signal from the network node. The passive RF device may move to an active or semi-passive operation based on energy level and/or periodicity. For instance, an RF device operating in a passive mode may move to a higher power mode (e.g., active or semi-passive) if energy harvested or stored by the RF device is enough for active communication, if a new battery is installed, or if enough charge has been supplied to the battery power. As another example, switching power mode may be timed, e.g., based on a periodicity. An RF device operating in passive mode may attempt to move to a higher power mode, for example. It may also be configured to do so based on a change in communication with the network node, e.g., if the network node has stopped communicating with it.

In some embodiments, an active RF device may switch to another power mode. More specifically, the active RF device may fall back to a passive mode or a semi-passive mode based on, e.g., stored energy (e.g., battery level) and/or the signal power information. Similarly, a semi-passive RF device may be configured to fall back to passive mode. RF devices which are passive in nature may remain agnostic to the above registration process and may continue to operate via backscattering.

A passive mode may refer to a state in which an active or semi-passive RF device no longer uses active transmit capabilities. A semi-passive mode may refer to a state in which an active RF device uses backscattering and limited transmit capabilities (e.g., where the signal received from the network node is below a threshold power, or at longer, more infrequent time intervals).

In some implementations, if the network node has determined that backscattered signals are not reached or decoded within n number of attempts from an RF device, then the network node may cease to perform operations involving passive RF devices (including expecting backscattered signals) and wait for re-entry of RF devices in a higher (e.g., active) mode as discussed below.

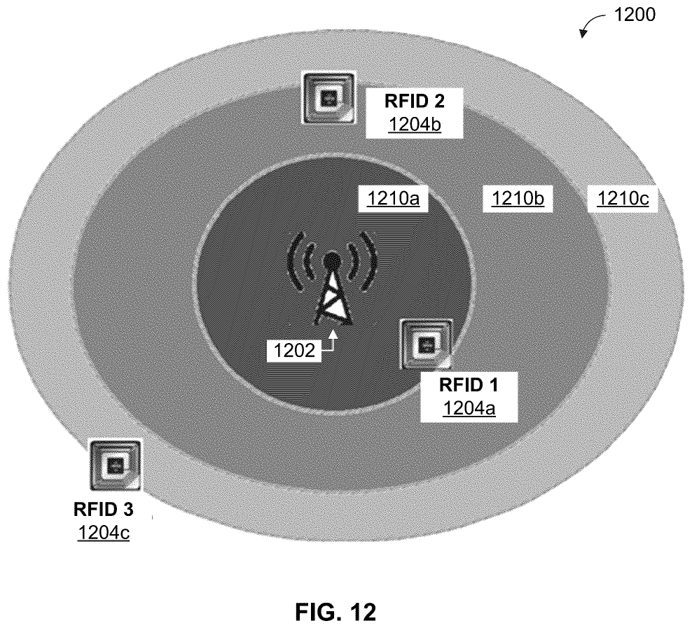

Consider the example scenario of a wireless environment 1200 depicted in FIG. 12, where a base station 1202 and multiple active RF devices 1204a, 1204b, 1204c are located at different distances from the base station. For example, active RF device 1204a may be within a region 1210a closest to the base station 1202, active RF device 1204b may be within a region 1210b next closest to the base station 1202, and active RF device 1204c may be within a region 1210c farthest from the base station 1202.

In some embodiments, a difference between uplink received power target at the base station 1202 and the returning power received at the base station may be determined by the base station 1202. The uplink power target and the returning power may be determined and/or known to the base station 1202 as described with respect to FIG. 11 above. The uplink power target may be an example of uplink power target 1105, and the returning power may be an example of returning power 1107. In FIG. 11, this difference is denoted as x dB.

In some scenarios, if x is less than the difference between the maximum transmit power (e.g., 1101) and the actual transmit power (e.g., 1104), the base station 1202 can boost its transmit power. There would be no need to compensate for underlying path loss to bring the returning power to an acceptable level. No amplification is needed at the RF device. For example, RF device 1204a (RFID 1) that is an active RF device in region 1210a may fall back to a passive mode or a semi-passive mode, since it would be able to send back sufficient backscatter power. If the RF device 1204a is a semi-passive RF device, it may fall back to a passive mode.

To enable this fallback adjustment at the RF device, in some implementations, the base station 1202 may send a signal to provide an indication or instruction to the RF device that it may adjust the power mode of the RF device to semi-passive and/or passive mode. In some implementations, the base station 1202 may send the signal power information (including, e.g., the difference x) so that the RF device can determine whether to an adjustment to its power mode.

In some scenarios, if x is greater than the difference between the maximum transmit power and the actual transmit power, the base station 1202 may provide an amplification for the RF device. The base station 1202 may boost the transmit power, up to the maximum transmit power. Additionally, the RF device may provide its own minor boost to help bring the returning power to an acceptable level. Such RF device may use its stored power for this purpose as the minor boost may not require a large amount of power. For example, RF device 1204b (RFID 2) that is an active RF device in region 1210b may fall back to a semi-passive mode, thereby still saving power (as compared to when operating as an active RF device) while receiving signals with a higher transmit power from the base station 1202.

In some scenarios, if x is much greater than the difference between the maximum transmit power and the actual transmit power, the base station 1202 may not be able to compensate the transmit power via amplification or allow the RF device to fall back to a lower, more passive power mode. For example, RF device 1204c (RFID 3) that is an active RF device in region 1210c may continue to operate in active mode. RF device 1204c may not fall back to a semi-passive or passive mode because otherwise it may not be able to communicate properly with the base station 1202.

Operation of an RF device as an active RF device and the fallback toward semi-passive or passive mode, may be based on monitoring of the wireless environment 1200 over time. As noted above, the RF device may, for instance, have mobility and change its location, which may result in insufficient signal power or uneven power across multiple RF device (leading to, e.g., failure to converge AGC). As a result, in some implementations, the base station 1202 may adjust its transmit power by increasing or decreasing it. Additionally or alternatively, in some implementations, more or less internal energy from the RF device may be needed to boost the returning signal, for instance, as the RF device moves farther away from or closer to the base station. Adjusting the internal energy of the RF device may involve switching power mode among active, semi-passive, and passive based on abovementioned changes over time and/or based on x as described in above scenarios.

Furthermore, as alluded to elsewhere above, in some implementations, the trigger for the various possible adjustments in RF device power mode and/or base station transmit power may be threshold based or on demand from the RF device (e.g., based on the RF device's internal power or battery level). In some approaches, the threshold in this case may be based on a comparison of x and the difference between the maximum transmit power and the actual transmit power, as discussed in the scenarios above, or based on the difference in signal strengths between backscattered signals from RF devices crossing a certain threshold, as noted above.

Advantageously, falling back to a more passive power mode may result in power savings and less complex operation of the RF devices. Additionally, a network node such as a base station may leverage the RF devices operating in a passive or semi-passive mode (and thus backscattering at least some signals) by allocating transmit power according to the embodiments described above.

In some embodiments, however, an RF device may re-enter active mode or semi-passive mode from a passive mode or from a fallback state. The capabilities of an RF device may be limited when it operates in a fallback mode as compared to a higher power mode. Hence, it may be desirable to operate the RF device at its full capability in some cases. For example, a more active mode may enable better sensitivity to listen to signals and ability to send data to other devices (including at greater range) via active transmission. If the RF device is able to harvest or access enough energy to operate at full capability, it may be able to come out of a lower power mode or a fallback mode to its original mode.

In some scenarios, an RF device that is capable of active or semi-passive mode may switch from passive mode (whether from a fallback state or a natively passive state) to a semi-passive or active mode if the RF device has sufficient energy available. The RF device in the fallback state or lower power (passive) mode may inform the receiver (e.g., base station) with an indication that it has sufficient energy (e.g., battery charge, availability or accessibility of power) to operate in a higher power mode. In some implementations, if the RF device is in passive mode, it may backscatter a signal containing the indication and a request to change the power mode, where the backscattered signal may have unique signal characteristics (e.g., relating to timing resource, frequency resource, and/or transmit power) to send the indication and request to the base station with an intent to switch to a higher power mode.

An RF device that has re-entered a higher power mode may send a signal to the network node to indicate that the RF device may perform operations involving active transmission of signals at least partly.

For example, referring again to FIG. 12, assume a scenario in which RF device 1204a (RFID 1) fell back to operate as a passive RF device from an active or semi-passive mode. In some implementations, the RF device 1204a may switch its power mode from passive mode to a higher power mode, such as active or semi-passive, based on the energy state of the RF device (e.g., battery level over a threshold, battery drain rate below a threshold, restored availability or accessibility of power) and/or based on a grant from the base station. The base station may receive the request for changing power mode via the unique backscattered signal from the passive RF device, the unique signal containing the request and an indication of sufficient energy. The base station may then determine when to accept the request and allow the power mode to be switched to a higher mode. For example, the base station may allow the switch to occur after termination or completion of any ongoing communication with the RF device.

In some scenarios, an RF device that is capable of active mode may switch from semi-passive mode to an active mode. Unlike passive RF devices that can only backscatter signals and hence may send a signal with unique characteristics as discussed above, a semi-passive device may be capable of sending an active uplink signal indicating its intent to switch to active mode, whether switching back from a fallback state or from its native semi-passive state.

For example, assume a scenario in which RF device 1204b (RFID 2) fell back to operate as a semi-passive RF device from an active mode. In some implementations, the RF device 1204b may switch its power mode from semi-passive mode to the higher active mode based on the energy state of the RF device. The base station may receive the intent to switch power mode and a request to change power mode via an active signal from the RF device 1204b.

### Example Methods

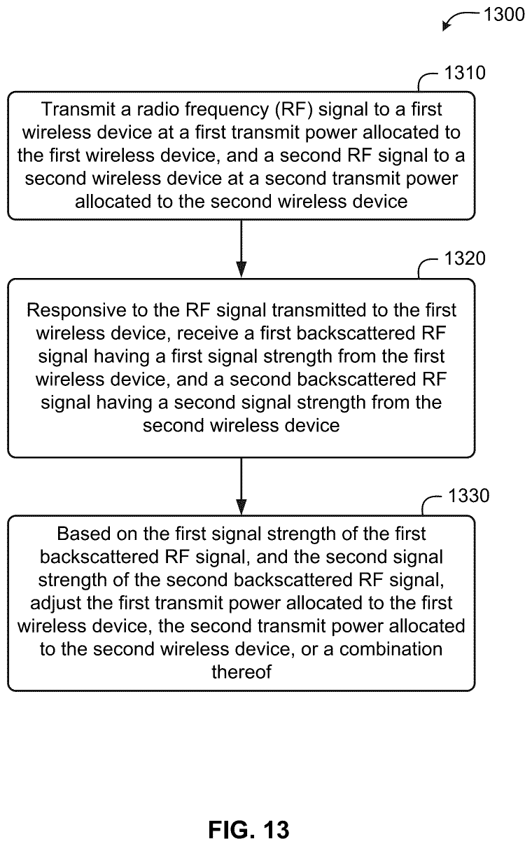

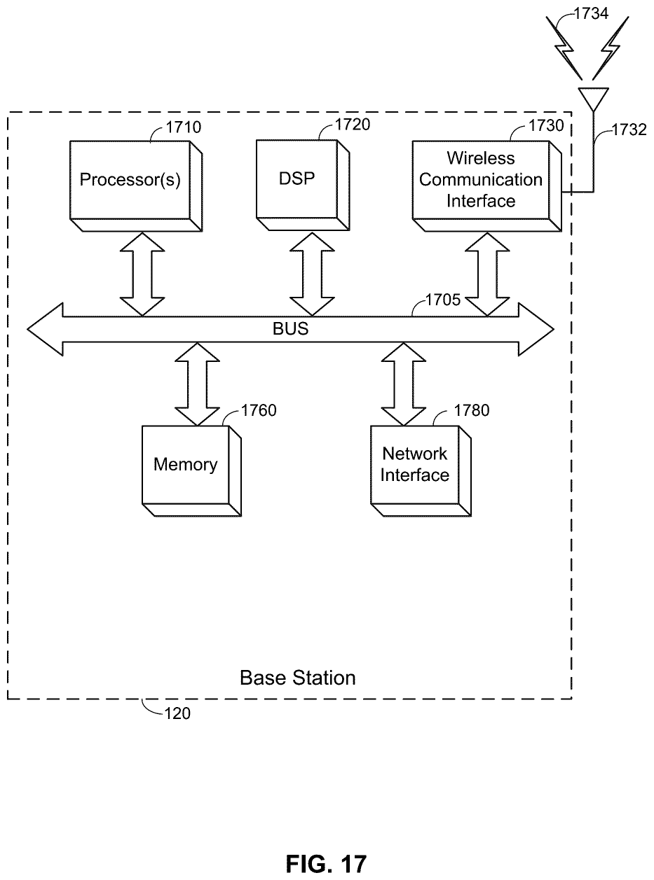

FIG. 13 is a flow diagram of an example of a method 1300 of dynamically controlling transmit power with respect to wireless devices, according to some embodiments. Structure for performing the functionality illustrated in one or more of the blocks shown in FIG. 13 may hardware and/or software components of a network node such as a base station. Example components may include a controller or processor apparatus, one or more processors, a computerized system, or a computer-readable apparatus including a storage medium storing computer-readable and/or computer-executable instructions that are configured to, when executed by one or more processors, cause the one or more processors or the network node to perform the operations. Example components of a base station are illustrated in FIG. 17, described in more detail below.

It should also be noted that the operations of FIG. 13 may be performed in any suitable order, not necessarily the order depicted in FIG. 13. Further, the process shown in FIG. 13 may include additional or fewer operations than those depicted in FIG. 13.

At block 1310, the method 1300 may include transmitting a radio frequency (RF) signal to a first wireless device at a first transmit power allocated to the first wireless device, and a second RF signal to a second wireless device at a second transmit power allocated to the second wireless device.

In some embodiments, the first wireless device and the second wireless device may each include a passive radio-frequency identification (RFID) device or a semi-passive RFID device configured to backscatter a received RF signal.

Means for performing functionality at block 1310 may include a wireless communication interface 1730, communication antenna(s) 1732, and/or other components of a base station, as illustrated in FIG. 17.

At block 1320, the method 1300 may include, responsive to the RF signal transmitted to the first wireless device, receiving a first backscattered RF signal having a first signal strength from the first wireless device, and a second backscattered RF signal having a second signal strength from the second wireless device.

Means for performing functionality at block 1310 may include a wireless communication interface 1730, communication antenna(s) 1732, and/or other components of a base station, as illustrated in FIG. 17.

At block 1330, the method 1300 may include, based on the first signal strength of the first backscattered RF signal, and the second signal strength of the second backscattered RF signal, adjusting the first transmit power allocated to the first wireless device, the second transmit power allocated to the second wireless device, or a combination thereof.

In some approaches, the adjusting of the first transmit power, the second transmit power, or the combination thereof may be based on a reference signal strength.

In some embodiments, prior to the adjusting of the first transmit power, the second transmit power, or the combination thereof: the first transmit power and the second transmit power may be substantially equal; and the first signal strength of the first backscattered RF signal and the second signal strength of the second backscattered RF signal may be unequal by a first amount. In some approaches, subsequent to the adjusting of the first transmit power, the second transmit power, or the combination thereof: the first transmit power and the second transmit power may be unequal; and the first signal strength of the first backscattered RF signal and the second signal strength of the second backscattered RF signal may be unequal by a second amount lower than the first amount. In some approaches, subsequent to the adjusting of the first transmit power, the second transmit power, or the combination thereof, the first signal strength of the first backscattered RF signal and the second signal strength of the second backscattered RF signal may be equal.

In some embodiments, the adjusting of the first transmit power, the second transmit power, or the combination thereof may be further based on a difference between the first signal strength and the second signal strength meeting or exceeding a threshold.

In some embodiments, the adjusting of the first transmit power, the second transmit power, or the combination thereof may be performed at a fixed interval.

Means for performing functionality at block 1310 may include processors 1710 and/or other components of a base station, as illustrated in FIG. 17.

In some embodiments, the method 1300 may further include readjusting the first transmit power, the second transmit power, or the combination thereof based on a change in the first signal strength of the first backscattered RF signal, the second signal strength of the second backscattered RF signal, or a combination thereof. In some implementations, the readjusting may be performed at an interval that is determined based on a frequency of the change in the first signal strength of the first backscattered RF signal, the second signal strength of the second backscattered RF signal, or the combination thereof.

In some embodiments, the method 1300 may further include determining a first signal path loss associated with the RF signal transmitted to the first wireless device based on the first signal strength, and a second signal path loss associated with the RF signal transmitted to the second wireless device based on the second signal strength; wherein the adjusting of the first transmit power, the second transmit power, or the combination thereof may be further based on the first signal path loss and the second signal path loss.

In some embodiments, the method 1300 may further include receiving a request from the first wireless device. In some implementations, the adjusting of the first transmit power, the second transmit power, or the combination thereof may be further based on the request from the first wireless device.

In some embodiments, the method 1300 may further include determining a first distance to the first wireless device based on the first signal strength, and a second distance to the second wireless device based on the second signal strength; wherein the adjusting of the first transmit power, the second transmit power, or the combination thereof is further based on the first distance and the second distance.

In some embodiments, the method 1300 may further include, subsequent to the adjusting of the first transmit power, the second transmit power, or the combination thereof: transmitting a second RF signal to the first wireless device at the first transmit power or the adjusted first transmit power at a first time; and transmitting a third RF signal to the second wireless device at the second transmit power or the adjusted second transmit power at a second time subsequent to the first time. In some implementations, the second RF signal to the first wireless device may be associated with a first signal frequency resource, and the second RF signal to the second wireless device may be associated with a second signal frequency resource.

In some implementations, the method 1300 may further include transmitting a third RF signal associated with a third signal frequency resource to a third wireless device at the first time, the second time, or a third time, the third signal frequency resource being different from the first frequency resource.

In some embodiments, the method 1300 may further include transmitting an adjusted RF signal at the adjusted first transmit power to the first wireless device, transmitting an adjusted RF signal at the adjusted second transmit power to the second wireless device, or a combination thereof.

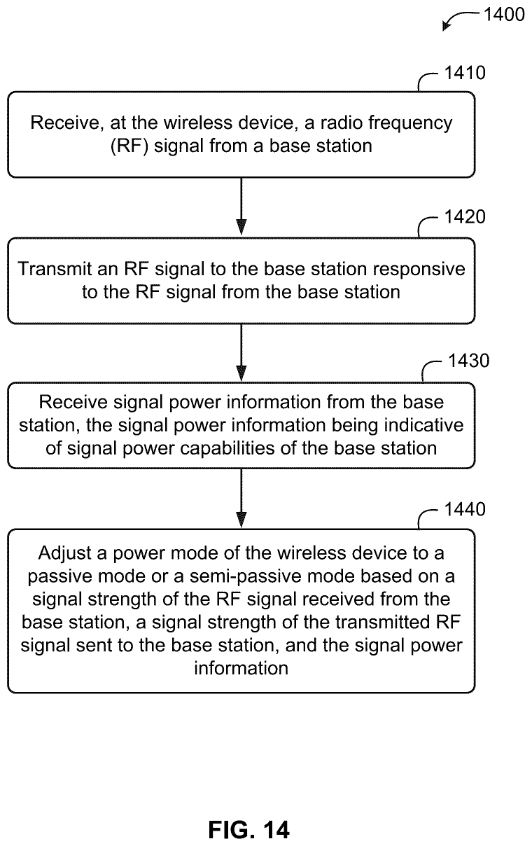

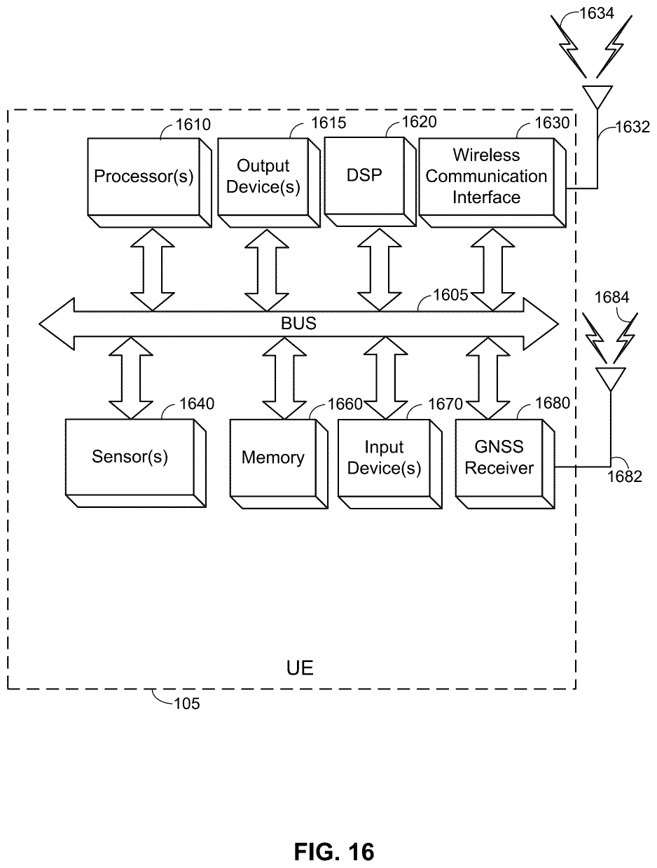

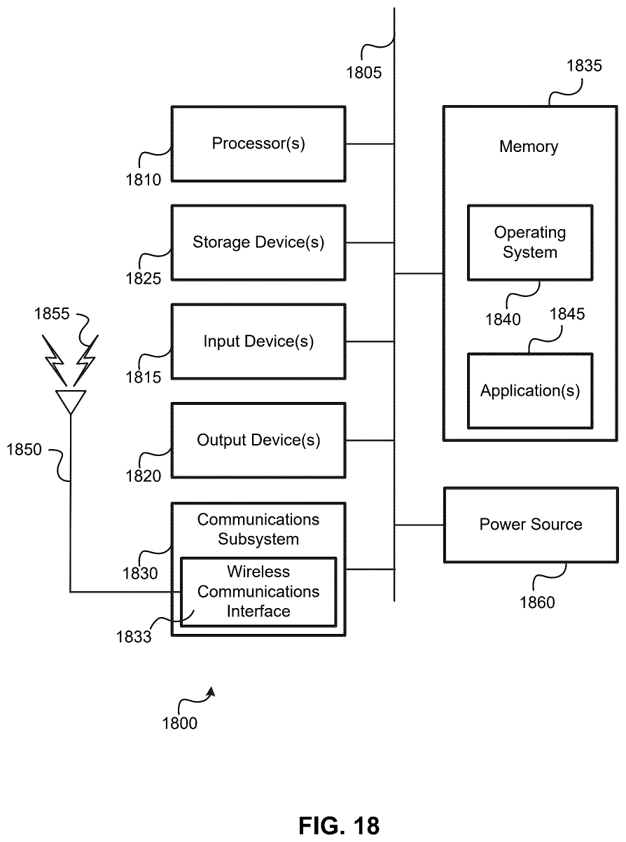

FIG. 14 is a flow diagram of an example of a method 1400 of dynamically controlling a power mode of a wireless device, according to some embodiments. Structure for performing the functionality illustrated in one or more of the blocks shown in FIG. 14 may hardware and/or software components of a wireless-enabled device, such as an RF device (e.g., RFID device), a mobile device, or a UE. Example components may include a controller or processor apparatus, one or more processors, a computerized system, or a computer-readable apparatus including a storage medium storing computer-readable and/or computer-executable instructions that are configured to, when executed by one or more processors, cause the one or more processors or the network node to perform the operations. Example components of a UE and an RF device are illustrated in FIGS. 16 and 18, respectively, described in more detail below.

It should also be noted that the operations of FIG. 14 may be performed in any suitable order, not necessarily the order depicted in FIG. 14. Further, the process shown in FIG. 14 may include additional or fewer operations than those depicted in FIG. 14.

At block 1410, the method 1400 may include receiving, at the wireless device, a radio frequency (RF) signal from a base station. In some embodiments, the wireless device may include or have access to an internal power source, and may comprise an active or semi-passive RFID device.

Means for performing functionality at block 1410 may include wireless communication interface 1630 or communications subsystem 1830 and/or other components of a UE or computer system, as illustrated in FIG. 16 or 18.

At block 1420, the method 1400 may include transmitting an RF signal to the base station responsive to the RF signal from the base station. In some cases, the transmitted RF signal to the base station may be at least partly backscattered from the received RF signal from the base station, e.g., if the wireless device comprises a semi-passive RFID device. In some cases, the transmitted RF signal to the base station may be fully actively transmitted responsive to the received RF signal from the base station, e.g., if the wireless device comprises an active RFID device.

Means for performing functionality at block 1420 may include wireless communication interface 1630 or communications subsystem 1830 and/or other components of a UE or computer system, as illustrated in FIG. 16 or 18.

At block 1430, the method 1400 may include receiving signal power information from the base station, the signal power information being indicative of signal power capabilities of the base station.

In some embodiments, the signal power information received from the base station may include a maximum transmit power associated with the base station and an uplink target power associated with the base station; and the wireless device may include: an active RFID device or a semi-passive RFID device configured to switch to a passive RFID mode, responsive to a difference between the maximum transmit power and the signal strength of the RF signal received from the base station being greater than a difference between the uplink target power and the signal strength of the transmitted RF signal sent to the base station; or an active RFID device configured to switch to the semi-passive RFID mode, responsive to a difference between the maximum transmit power and the signal strength of the RF signal received from the base station being lower than a difference between the uplink target power and the signal strength of the transmitted RF signal sent to the base station.

In some embodiments, the signal power information may include a maximum transmit power associated with the base station, a minimum transmit power associated with the base station, the signal strength of the RF signal received from the base station, an uplink power target, or a combination thereof.

Means for performing functionality at block 1430 may include wireless communication interface 1630 or communications subsystem 1830 and/or other components of a UE or computer system, as illustrated in FIG. 16 or 18.

At block 1440, the method 1400 may include adjusting a power mode of the wireless device to a passive mode or a semi-passive mode based on a signal strength of the RF signal received from the base station, a signal strength of the transmitted RF signal sent to the base station, and the signal power information.

In some embodiments, the wireless device may include an active radio frequency identification (RFID) device or a semi-passive RFID device, and the adjusting of the power mode of the wireless device may include switching to a passive RFID mode. In some implementations, the signal power information received from the base station may include a maximum transmit power associated with the base station and an uplink target power associated with the base station; and the switching to the passive RFID mode may be responsive to a difference between the maximum transmit power and the signal strength of the RF signal received from the base station being greater than a difference between the uplink target power and the signal strength of the transmitted RF signal sent to the base station.

In some embodiments, the wireless device may include an active RFID device, and the adjusting of the power mode of the wireless device may include switching to a semi-passive RFID mode. In some implementations, the signal power information received from the base station may include a maximum transmit power associated with the base station and an uplink target power associated with the base station; and the switching to the semi-passive RFID mode may be responsive to a difference between the maximum transmit power and the signal strength of the RF signal received from the base station being lower than a difference between the uplink target power and the signal strength of the transmitted RF signal sent to the base station.

Means for performing functionality at block 1440 may include processor(s) 1610 or processor(s) 1810 and/or other components of a UE or computer system, as illustrated in FIG. 16 or 18.

In some embodiments, the method 1400 may further include, subsequent to the adjusting of the power mode of the wireless device, receiving a second RF signal from the base station, the second RF signal having an adjusted signal strength.

In some embodiments, the method 1400 may further include adjusting the power mode of the wireless device by re-entering an active mode from the passive mode or the semi-passive mode, or re-entering the semi-passive mode from the passive mode. In some implementations, the method 1400 may further include sending, to the base station, a request to re-enter the power mode or the semi-passive mode; and the re-entry may be based on an instruction from the base station allowing the re-entry. In some examples, the base station may allow the switch to occur after termination or completion of any ongoing communication with the wireless device. In some cases, the wireless device may comprise an active RFID device or a semi-passive RFID device, operating in the adjusted power mode of the passive mode; and the request to the base station may be sent via a backscattered RF signal having unique signal characteristics indicative of an intent to adjust the power mode to the active mode.

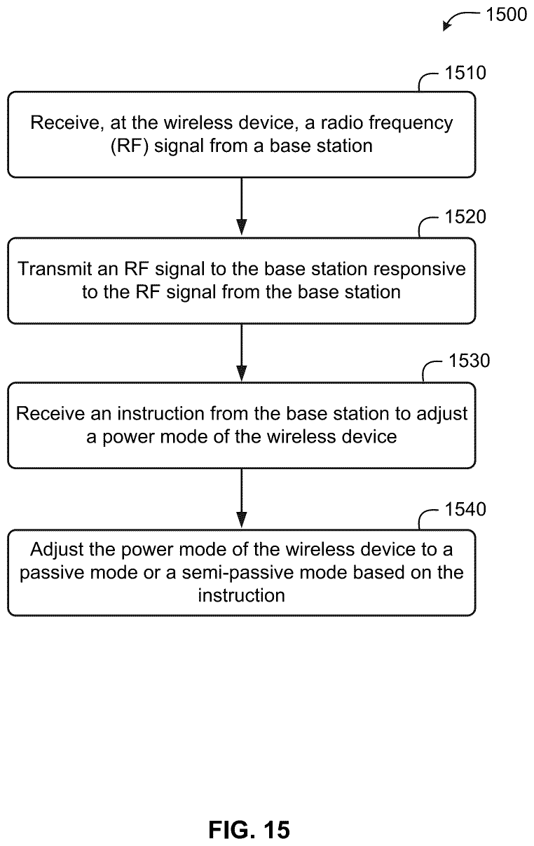

FIG. 15 is a flow diagram of an example of a method 1500 of dynamically controlling a power mode of a wireless device, according to some embodiments. Structure for performing the functionality illustrated in one or more of the blocks shown in FIG. 15 may hardware and/or software components of a wireless-enabled device, such as an RF device (e.g., RFID device), a mobile device, or a UE. Example components may include a controller or processor apparatus, one or more processors, a computerized system, or a computer-readable apparatus including a storage medium storing computer-readable and/or computer-executable instructions that are configured to, when executed by one or more processors, cause the one or more processors or the network node to perform the operations. Example components of a UE and an RF device are illustrated in FIGS. 16 and 18, respectively, described in more detail below.

It should also be noted that the operations of FIG. 15 may be performed in any suitable order, not necessarily the order depicted in FIG. 15. Further, the process shown in FIG. 15 may include additional or fewer operations than those depicted in FIG. 15.

Blocks 1510 and 1520 may be examples of blocks 1410 and 1420, respectively, discussed above.

At block 1530, the method 1500 may include receiving an instruction from the base station to adjust a power mode of the wireless device.

In some embodiments, the wireless device may comprise an active RFID device or a semi-passive RFID device; and the base station may determine, based on signal power information, that the wireless device may switch to a passive mode.

In some embodiments, the wireless device may comprise an active RFID device; and the base station may determine, based on signal power information, that the wireless device may switch to a semi-passive mode or a passive mode.

At block 1540, the method 1500 may include adjusting the power mode of the wireless device to a passive mode or a semi-passive mode based on the instruction.

In some embodiments, the method 1500 may further include adjusting the power mode of the wireless device by re-entering an active mode from the passive mode or the semi-passive mode, or re-entering the semi-passive mode from the passive mode. In some implementations, the method 1500 may further include sending, to the base station, a request to re-enter the power mode or the semi-passive mode; and the re-entry may be based on another instruction from the base station allowing the re-entry. In some examples, the base station may allow the switch to occur after termination or completion of any ongoing communication with the wireless device. In some cases, the wireless device may comprise an active RFID device or a semi-passive RFID device, operating in the adjusted power mode of the passive mode; and the request to the base station may be sent via a backscattered RF signal having unique signal characteristics indicative of an intent to adjust the power mode to the active mode.

### Apparatus

FIG. 16 is a block diagram of an embodiment of a UE 105, which can be utilized as described herein above (e.g., in association with FIGS. 4-7, 11, 12 and 14). For example, the UE 105 can perform one or more of the functions of the method shown in FIG. 14 or 15. It should be noted that FIG. 16 is meant only to provide a generalized illustration of various components, any or all of which may be utilized as appropriate. It can be noted that, in some instances, components illustrated by FIG. 16 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 16.

The UE 105 is shown comprising hardware elements that can be electrically coupled via a bus 1605 (or may otherwise be in communication, as appropriate). The hardware elements may include a processor(s) 1610 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1610 may comprise one or more processing units, which may be housed in a single integrated circuit (IC) or multiple ICs. As shown in FIG. 16, some embodiments may have a separate DSP 1620, depending on desired functionality. Location determination and/or other determinations based on wireless communication may be provided in the processor(s) 1610 and/or wireless communication interface 1630 (discussed below). The UE 105 also can include one or more input devices 1670, which can include without limitation one or more keyboards, touch screens, touch pads, microphones, buttons, dials, switches, and/or the like; and one or more output devices 1615, which can include without limitation one or more displays (e.g., touch screens), light emitting diodes (LEDs), speakers, and/or the like.

The UE 105 may also include a wireless communication interface 1630, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 1630 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1632 that send and/or receive wireless signals 1634. According to some embodiments, the wireless communication antenna(s) 1632 may comprise a plurality of discrete antennas, antenna arrays, or any combination thereof. The antenna(s) 1632 may be capable of transmitting and receiving wireless signals using beams (e.g., Tx beams and Rx beams). Beam formation may be performed using digital and/or analog beam formation techniques, with respective digital and/or analog circuitry. The wireless communication interface 1630 may include such circuitry.

Depending on desired functionality, the wireless communication interface 1630 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA 2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 1640. Sensor(s) 1640 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 1680 capable of receiving signals 1684 from one or more GNSS satellites using an antenna 1682 (which could be the same as antenna 1632). Positioning based on GNSS signal measurement can be utilized to complement and/or incorporate the techniques described herein. The GNSS receiver 1680 can extract a position of the UE 105, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1680 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1680 is illustrated in FIG. 16 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1610, DSP 1620, and/or a processor within the wireless communication interface 1630 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1610 or DSP 1620.

The UE 105 may further include and/or be in communication with a memory 1660. The memory 1660 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1660 of the UE 105 also can comprise software elements (not shown in FIG. 16), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1660 that are executable by the UE 105 (and/or processor(s) 1610 or DSP 1620 within UE 105). In some embodiments, then, such code and/or instructions can be used to configure and/or adapt a general-purpose computer (or other device) to perform one or more operations in accordance with the described methods.

FIG. 17 is a block diagram of an embodiment of a base station 120, which can be utilized as described herein above (e.g., in association with FIGS. 4-7, 11, 12 and 13). It should be noted that FIG. 17 is meant only to provide a generalized illustration of various components, any or all of which may be utilized as appropriate. In some embodiments, the base station 120 may correspond to a gNB, an ng-eNB, and/or (more generally) a TRP.

The base station 120 is shown comprising hardware elements that can be electrically coupled via a bus 1705 (or may otherwise be in communication, as appropriate). The hardware elements may include a processor(s) 1710 which can include without limitation one or more general-purpose processors, one or more special-purpose processors (such as DSP chips, graphics acceleration processors, ASICs, and/or the like), and/or other processing structure or means. As shown in FIG. 17, some embodiments may have a separate DSP 1720, depending on desired functionality. Location determination and/or other determinations based on wireless communication may be provided in the processor(s) 1710 and/or wireless communication interface 1730 (discussed below), according to some embodiments. The base station 120 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station 120 might also include a wireless communication interface 1730, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the base station 120 to communicate as described herein. The wireless communication interface 1730 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 1732 that send and/or receive wireless signals 1734.

The base station 120 may also include a network interface 1780, which can include support of wireline communication technologies. The network interface 1780 may include a modem, network card, chipset, and/or the like. The network interface 1780 may include one or more input and/or output communication interfaces to permit data to be exchanged with a network, communication network servers, computer systems, and/or any other electronic devices described herein.

In many embodiments, the base station 120 may further comprise a memory 1760. The memory 1760 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1760 of the base station 120 also may comprise software elements (not shown in FIG. 17), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1760 that are executable by the base station 120 (and/or processor(s) 1710 or DSP 1720 within base station 120). In some embodiments, then, such code and/or instructions can be used to configure and/or adapt a general-purpose computer (or other device) to perform one or more operations in accordance with the described methods.

FIG. 18 is a block diagram of an embodiment of a computer system 1800 such as a radio frequency (RF) device (e.g., a radio frequency identification (RFID) device), which may be used, in whole or in part, to provide the functions of one or more network components as described in the embodiments herein (e.g., RF device 1110 of FIG. 11 or RF devices 1204a-1204c of FIG. 12). For example, the computer system 1800 can perform one or more of the functions of the method shown in FIG. 14 or 15. It should be noted that FIG. 18 is meant only to provide a generalized illustration of various components, any or all of which may be utilized as appropriate. FIG. 18, therefore, broadly illustrates how individual system elements may be implemented in a relatively separated or relatively more integrated manner. In addition, it can be noted that components illustrated by FIG. 18 can be localized to a single device and/or distributed among various networked devices, which may be disposed at different geographical locations.

The computer system 1800 is shown comprising hardware elements that can be electrically coupled via a bus 1805 (or may otherwise be in communication, as appropriate). The hardware elements may include processor(s) 1810, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1800 also may comprise one or more input devices 1815, which may comprise without limitation a mouse, a keyboard, a camera, a microphone, and/or the like; and one or more output devices 1820, which may comprise without limitation a display device, a printer, and/or the like.

The computer system 1800 may further include (and/or be in communication with) one or more non-transitory storage devices 1825, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1800 may also include a communications subsystem 1830, which may comprise wireless communication technologies managed and controlled by a wireless communication interface 1833, as well as wired technologies (such as Ethernet, coaxial communications, universal serial bus (USB), and the like). The wireless communication interface 1833 may comprise one or more wireless transceivers that may send and receive wireless signals 1855 (e.g., signals according to 5G NR or LTE) via wireless antenna(s) 1850. Thus the communications subsystem 1830 may comprise a modem, a network card (wireless or wired), an infrared communication device, a wireless communication device, and/or a chipset, and/or the like, which may enable the computer system 1800 to communicate on any or all of the communication networks described herein to any device on the respective network, including a User Equipment (UE), base stations and/or other TRPs, and/or any other electronic devices described herein. Hence, the communications subsystem 1830 may be used to receive and send data as described in the embodiments herein.

In some embodiments, the computer system 1800 may include a power source 1860, which may be an internal power source such as a battery or other power supply disposed within a housing or chassis of the computer system 1800. In some embodiments, the power source 1860 may be an external battery or other power supply disposed outside the housing or chassis of the computer system 1800.

In many embodiments, the computer system 1800 will further comprise a working memory 1835, which may comprise a RAM or ROM device, as described above. Software elements, shown as being located within the working memory 1835, may comprise an operating system 1840, device drivers, executable libraries, and/or other code, such as one or more applications 1845, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1825 described above. In some cases, the storage medium might be incorporated within a computer system, such as computer system 1800. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1800 and/or might take the form of source and/or installable code, which, upon compilation and/or installation on the computer system 1800 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method of dynamically controlling a power mode of a wireless device, the method comprising: receiving, at the wireless device, a radio frequency (RF) signal from a base station; transmitting an RF signal to the base station responsive to the RF signal from the base station; receiving signal power information from the base station, the signal power information being indicative of signal power capabilities of the base station; and adjusting a power mode of the wireless device to a passive mode or a semi-passive mode based on a signal strength of the RF signal received from the base station, a signal strength of the transmitted RF signal sent to the base station, and the signal power information.

Clause 2. The method of clause 1, wherein the wireless device comprises an active radio frequency identification (RFID) device or a semi-passive RFID device, and the adjusting of the power mode of the wireless device comprises switching to a passive RFID mode.

Clause 3. The method of clause 2, wherein: the signal power information received from the base station comprises a maximum transmit power associated with the base station and an uplink target power associated with the base station; and the switching to the passive RFID mode is responsive to a difference between the maximum transmit power and the signal strength of the RF signal received from the base station being greater than a difference between the uplink target power and the signal strength of the transmitted RF signal sent to the base station.

Clause 4. The method of clause 1, wherein the wireless device comprises an active radio frequency identification (RFID) device, and the adjusting of the power mode of the wireless device comprises switching to a semi-passive RFID mode.

Clause 5. The method of clause 4, wherein: the signal power information received from the base station comprises a maximum transmit power associated with the base station and an uplink target power associated with the base station; and the switching to the semi-passive RFID mode is responsive to a difference between the maximum transmit power and the signal strength of the RF signal received from the base station being lower than a difference between the uplink target power and the signal strength of the transmitted RF signal sent to the base station.

Clause 6. The method of clause 1, wherein: the signal power information received from the base station comprises a maximum transmit power associated with the base station and an uplink target power associated with the base station; and the wireless device comprises: an active radio frequency identification (RFID) device or a semi-passive RFID device configured to switch to a passive RFID mode, responsive to a difference between the maximum transmit power and the signal strength of the RF signal received from the base station being greater than a difference between the uplink target power and the signal strength of the transmitted RF signal sent to the base station; or an active RFID device configured to switch to the semi-passive RFID mode, responsive to a difference between the maximum transmit power and the signal strength of the RF signal received from the base station being lower than a difference between the uplink target power and the signal strength of the transmitted RF signal sent to the base station.

Clause 7. The method of clause 1, wherein the wireless device comprises a semi-passive radio frequency identification (RFID) device, and the transmitted RF signal to the base station is at least partly backscattered from the received RF signal from the base station.

Clause 8. The method of clause 1, further comprising, subsequent to the adjusting of the power mode of the wireless device, receiving a second RF signal from the base station, the second RF signal having an adjusted signal strength.

Clause 9. The method of clause 1, wherein the signal power information comprising a maximum transmit power associated with the base station, a minimum transmit power associated with the base station, the signal strength of the RF signal received from the base station, an uplink power target, or a combination thereof.

Clause 10. The method of clause 1, further comprising adjusting the power mode of the wireless device by re-entering an active mode from the passive mode or the semi-passive mode, or re-entering the semi-passive mode from the passive mode.

Clause 11. The method of clause 10, further comprising sending, to the base station, a request to re-enter the power mode or the semi-passive mode; wherein the re-entry is based on an instruction from the base station allowing the re-entry.

Clause 12. The method of clause 11, wherein: the wireless device comprises an active radio frequency identification (RFID) device or a semi-passive RFID

device, operating in the adjusted power mode of the passive mode; and the request to the base station is sent via a backscattered RF signal having unique signal characteristics indicative of an intent to adjust the power mode to the active mode.

Clause 13. A wireless device comprising: one or more wireless communication interfaces; one or more memories; a power source; and one or more processors communicatively coupled with the one or more wireless communication interfaces, the one or more memories, and the power source, wherein the one or more processors are configured to: receive a radio frequency (RF) signal from a base station; transmit an RF signal to the base station responsive to the RF signal from the base station; receive signal power information from the base station, the signal power information being indicative of signal power capabilities of the base station; and adjust a power mode of the wireless device to a passive mode or a semi-passive mode based on a signal strength of the RF signal received from the base station; a signal strength of the transmitted RF signal sent to the base station, and the signal power information.

Clause 14. The wireless device of clause 13, further comprising an active radio frequency identification (RFID) device or a semi-passive RFID device configured to, responsive to the adjusting of the power mode, switch to a passive RFID mode.

Clause 15. The wireless device of clause 14, wherein: the signal power information received from the base station comprises a maximum transmit power associated with the base station and an uplink target power associated with the base station; and the switching to the passive RFID mode is responsive to a difference between the maximum transmit power and the signal strength of the RF signal received from the base station being greater than a difference between the uplink target power and the signal strength of the transmitted RF signal sent to the base station.

Clause 16. The wireless device of clause 13, further comprising an active radio frequency identification (RFID) device configured to, responsive to the adjusting of the power mode, switch to a semi-passive RFID mode or a passive RFID mode.

Clause 17. The wireless device of clause 16, wherein: the signal power information received from the base station comprises a maximum transmit power associated with the base station and an uplink target power associated with the base station; and the switching to the semi-passive RFID mode is responsive to a difference between the maximum transmit power and the signal strength of the RF signal received from the base station being lower than a difference between the uplink target power and the signal strength of the transmitted RF signal sent to the base station.

Clause 18. An apparatus comprising: means for receiving, at the wireless device, a radio frequency (RF) signal from a base station; means for transmitting an RF signal to the base station responsive to the RF signal from the base station; means for receiving signal power information from the base station, the signal power information being indicative of signal power capabilities of the base station; and means for adjusting a power mode of the wireless device to a passive mode or a semi-passive mode based on a signal strength of the RF signal received from the base station, a signal strength of the transmitted RF signal sent to the base station, and the signal power information.

Clause 19. The apparatus of clause 18, wherein: the wireless device comprises an active radio frequency identification (RFID) device or a semi-passive RFID device, and the adjusting of the power mode of the wireless device comprises switching to a passive RFID mode; the signal power information received from the base station comprises a maximum transmit power associated with the base station and an uplink target power associated with the base station; and the switching to the passive RFID mode is responsive to a difference between the maximum transmit power and the signal strength of the RF signal received from the base station being greater than a difference between the uplink target power and the signal strength of the transmitted RF signal sent to the base station.

Clause 20. The apparatus of clause 18, wherein: the wireless device comprises an active radio frequency identification (RFID) device, and the adjusting of the power mode of the wireless device comprises switching to a semi-passive RFID mode; the signal power information received from the base station comprises a maximum transmit power associated with the base station and an uplink target power associated with the base station; and the switching to the semi-passive RFID mode is responsive to a difference between the maximum transmit power and the signal strength of the RF signal received from the base station being lower than a difference between the uplink target power and the signal strength of the transmitted RF signal sent to the base station.

What is claimed is:

1. A method of dynamically controlling a power mode of a wireless device, the method comprising:
receiving, at the wireless device, a radio frequency (RF) signal from a base station;
transmitting an RF signal to the base station responsive to the RF signal from the base station;
receiving signal power information from the base station, the signal power information being indicative of signal power capabilities of the base station; and
adjusting a power mode of the wireless device to a passive mode or a semi-passive mode based on a signal strength of the RF signal received from the base station, a signal strength of the transmitted RF signal sent to the base station, and the signal power information.

2. The method of claim 1, wherein the wireless device comprises an active radio frequency identification (RFID) device or a semi-passive RFID device, and the adjusting of the power mode of the wireless device comprises switching to a passive RFID mode.

3. The method of claim 2, wherein:
the signal power information received from the base station comprises a maximum transmit power associated with the base station and an uplink target power associated with the base station; and
the switching to the passive RFID mode is responsive to a difference between the maximum transmit power and the signal strength of the RF signal received from the base station being greater than a difference between the uplink target power and the signal strength of the transmitted RF signal sent to the base station.

4. The method of claim 1, wherein the wireless device comprises an active radio frequency identification (RFID) device, and the adjusting of the power mode of the wireless device comprises switching to a semi-passive RFID mode.

5. The method of claim 4, wherein:
the signal power information received from the base station comprises a maximum transmit power associated with the base station and an uplink target power associated with the base station; and
the switching to the semi-passive RFID mode is responsive to a difference between the maximum transmit power and the signal strength of the RF signal received from the base station being lower than a difference between the uplink target power and the signal strength of the transmitted RF signal sent to the base station.

6. The method of claim 1, wherein:
the signal power information received from the base station comprises a maximum transmit power associated with the base station and an uplink target power associated with the base station; and
the wireless device comprises:
an active radio frequency identification (RFID) device or a semi-passive RFID device configured to switch to a passive RFID mode, responsive to a difference between the maximum transmit power and the signal strength of the RF signal received from the base station being greater than a difference between the uplink target power and the signal strength of the transmitted RF signal sent to the base station; or
an active RFID device configured to switch to the semi-passive RFID mode, responsive to a difference between the maximum transmit power and the signal strength of the RF signal received from the base station being lower than a difference between the uplink target power and the signal strength of the transmitted RF signal sent to the base station.

7. The method of claim 1, wherein the wireless device comprises a semi-passive radio frequency identification (RFID) device, and the transmitted RF signal to the base station is at least partly backscattered from the received RF signal from the base station.

8. The method of claim 1, further comprising, subsequent to the adjusting of the power mode of the wireless device, receiving a second RF signal from the base station, the second RF signal having an adjusted signal strength.

9. The method of claim 1, wherein the signal power information comprising a maximum transmit power associated with the base station, a minimum transmit power associated with the base station, the signal strength of the RF signal received from the base station, an uplink power target, or a combination thereof.

10. The method of claim 1, further comprising adjusting the power mode of the wireless device by re-entering an active mode from the passive mode or the semi-passive mode, or re-entering the semi-passive mode from the passive mode.

11. The method of claim 10, further comprising sending, to the base station, a request to re-enter the power mode or the semi-passive mode;
wherein the re-entry is based on an instruction from the base station allowing the re-entry.

12. The method of claim 11, wherein:
the wireless device comprises an active radio frequency identification (RFID) device or a semi-passive RFID device, operating in the adjusted power mode of the passive mode; and
the request to the base station is sent via a backscattered RF signal having unique signal characteristics indicative of an intent to adjust the power mode to the active mode.

13. A wireless device comprising:
one or more wireless communication interfaces;
one or more memories;
a power source; and
one or more processors communicatively coupled with the one or more wireless communication interfaces, the one or more memories, and the power source, wherein the one or more processors are configured to:
receive a radio frequency (RF) signal from a base station;
transmit an RF signal to the base station responsive to the RF signal from the base station;
receive signal power information from the base station, the signal power information being indicative of signal power capabilities of the base station; and
adjust a power mode of the wireless device to a passive mode or a semi-passive mode based on a signal strength of the RF signal received from the base station, a signal strength of the transmitted RF signal sent to the base station, and the signal power information.

14. The wireless device of claim 13, further comprising an active radio frequency identification (RFID) device or a semi-passive RFID device configured to, responsive to the adjusting of the power mode, switch to a passive RFID mode.

15. The wireless device of claim 14, wherein:
the signal power information received from the base station comprises a maximum transmit power associated with the base station and an uplink target power associated with the base station; and
the switching to the passive RFID mode is responsive to a difference between the maximum transmit power and the signal strength of the RF signal received from the base station being greater than a difference between the uplink target power and the signal strength of the transmitted RF signal sent to the base station.

16. The wireless device of claim 13, further comprising an active radio frequency identification (RFID) device configured to, responsive to the adjusting of the power mode, switch to a semi-passive RFID mode or a passive RFID mode.

17. The wireless device of claim 16, wherein:
the signal power information received from the base station comprises a maximum transmit power associated with the base station and an uplink target power associated with the base station; and
the switching to the semi-passive RFID mode is responsive to a difference between the maximum transmit power and the signal strength of the RF signal received from the base station being lower than a difference between the uplink target power and the signal strength of the transmitted RF signal sent to the base station.

18. An apparatus comprising:
means for receiving, at the wireless device, a radio frequency (RF) signal from a base station;
means for transmitting an RF signal to the base station responsive to the RF signal from the base station;
means for receiving signal power information from the base station, the signal power information being indicative of signal power capabilities of the base station; and
means for adjusting a power mode of the wireless device to a passive mode or a semi-passive mode based on a signal strength of the RF signal received from the base station, a signal strength of the transmitted RF signal sent to the base station, and the signal power information.

19. The apparatus of claim 18, wherein:
the wireless device comprises an active radio frequency identification (RFID) device or a semi-passive RFID device, and the adjusting of the power mode of the wireless device comprises switching to a passive RFID mode;
the signal power information received from the base station comprises a maximum transmit power associated with the base station and an uplink target power associated with the base station; and
the switching to the passive RFID mode is responsive to a difference between the maximum transmit power and the signal strength of the RF signal received from the base station being greater than a difference between the uplink target power and the signal strength of the transmitted RF signal sent to the base station.

20. The apparatus of claim 18, wherein:
the wireless device comprises an active radio frequency identification (RFID) device, and the adjusting of the power mode of the wireless device comprises switching to a semi-passive RFID mode;
the signal power information received from the base station comprises a maximum transmit power associated with the base station and an uplink target power associated with the base station; and
the switching to the semi-passive RFID mode is responsive to a difference between the maximum transmit power and the signal strength of the RF signal received from the base station being lower than a difference between the uplink target power and the signal strength of the transmitted RF signal sent to the base station.
